(19) United States
(12) Patent Application Publication
(10) Pub. No.: US 2024/0159856 A1
(43) Pub. Date: May 16, 2024

(54) DETERMINING A LOCATION OF RFID TAG

(71) Applicant: Sys-pro GmbH, Berlin (DE)

(72) Inventor: Simon Walk, Graz (AT)

(21) Appl. No.: 18/551,132

(22) PCT Filed: Mar. 17, 2022
(86) PCT No.: PCT/GB2022/050679

§ 371 Date: Sep. 18, 2023

(30) Foreign Application Priority Data
Mar. 19, 2021 (GB) 2103840.1

(51) Int. Cl. G01S 5/02; G01S 13/75; H04B 17/318

(52) U.S. Cl. CPC G01S 5/0252; G01S 13/75; H04B 17/318; G01S 2201/02; G01S 2205/02

(57) ABSTRACT

A method of determining a location of an RFID tag may be provided. The method may comprise obtaining first received signal strength data associated with a first tag volume and relating to signals received from the tag at a first plurality of locations relative to the tag, and second received signal strength data associated with a second tag volume different from the first tag volume and relating to signals received from the tag at a second plurality of locations relative to the tag. The method may comprise determining, depending on the first and second received signal strength data, point of peak data indicative of a location with respect to the first and second tag volumes of peak received signal strength from the tag. The method may comprise determining value(s) of one or more further received signal parameters depending on the first and second received signal strength data. The method may comprise determining which of the first and second tag volumes the RFID tag is more likely to be located in depending on the point of peak data and on the determined values of the one or more further received signal parameters.

### BACKGROUND

Passive Radio frequency Identification (RFID) tags may be used for stock control and management. The tags, which may be encapsulated and fixed to a product or its packaging, can be read remotely, often at a distance of several metres, by way of an RFID reader which transmits and receives radio signals to and from the tag. A line of sight between the reader and the tag is not required. The information that the reader collects from the tags is collated and processed, typically by specialist computer software. Tags may be given unique identification codes by which stock items may be uniquely identified. Several tags corresponding to several stock items can be read at once, enabling a number of products to be checked simultaneously.

An issue which can arise with this method of stock control is that it can be difficult to determine the location of an RFID tag, and thus a stock item, accurately. For example it can be difficult to identify which room or floor an RFID tag and corresponding stock item are located, for example if there are two rooms or floors located adjacent to each other in which it is possible for the stock item to be located. Radio frequency, RF, signals can pass through walls, making it difficult to ascertain exactly which room or floor the tag is in or on. In addition, received signal strength values from the tag by the reader can depend not only on the distance of the tag from the reader and the presence of any objects between the tag and the reader, but also on the orientation of the tag relative to the reader. Therefore, received signal strength can be an unreliable indicator of where the tag and corresponding stock item are located.

One solution to this issue is to provide the mutual screening of rooms or floors so that signals from a tag in one room or floor cannot be detected in an adjacent room or floor. This screening may be done by covering the wall with aluminium foil, for example. However this requires significant effort and expense and can interfere with transmission and reception of wireless communications signals, such as cellular communications signals, which can cause inconvenience to customers.

### BRIEF DESCRIPTION OF THE DRAWINGS

Examples are further described with reference to the accompanying drawings, in which:

FIG. 1 schematically illustrates an RFID reader detecting signals from an RFID tag in each of two adjacent rooms;

FIG. 2 is a block diagram of an example RFID reader;

FIG. 3 shows example signal strengths received from the RFID tag by a mobile RFID tag reader at various locations within the respective rooms;

FIG. 4 is a flow chart illustrating a method of determining a location of an RFID tag;

FIG. 5 is a flow chart illustrating a method of determining a location of an RFID tag using a trained machine learning model, such as the trained machine learning model provided by the method of FIG. 7;

FIG. 6a illustrates a simplified decision tree;

FIGS. 6b-6d illustrate an example gradient boosted decision tree;

FIG. 7 is a flow chart illustrating a method of training a machine learning model for determining the location of the RFID tag;

FIGS. 8a and 8b show the results of first and second field trials in which three different methods were used to determine which room of two possible rooms a number of different RFID tags were located in;

FIG. 9 is a table showing a comparison of different methods of determining which room of two possible rooms a number of different RFID tags were located in; and

FIG. 10 schematically illustrates a conveyor belt having three containers including RFID tags and corresponding stock items, an RFID reader being provided adjacent to the conveyor belt.

### DETAILED DESCRIPTION

Features, integers or characteristics described in conjunction with a particular aspect or example are to be understood to be applicable to any other aspect or example described herein unless incompatible therewith.

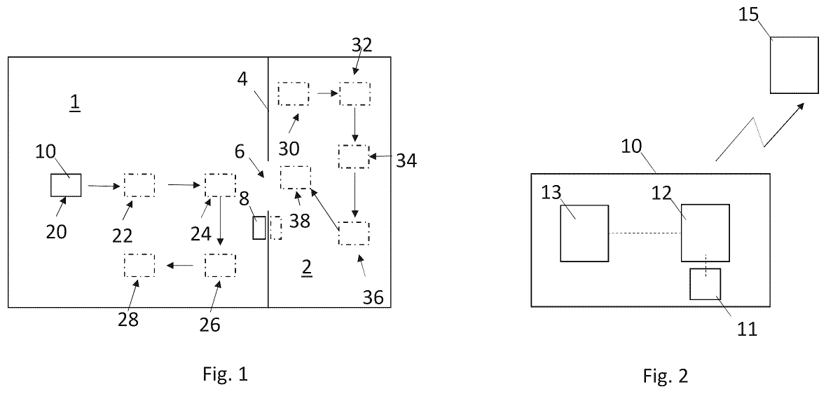

FIG. 1 is a schematic diagram showing first and second rooms 1, 2 which are adjacent to each other and separated by a wall 4 comprising a doorway 6. It may be that the wall 4 dividing the first and second rooms 1, 2 is unshielded—that is, it is not provided with conductive material, such as a conductive coating or covering, which substantially inhibits the passage of RF signals through the wall 4. It may be that the wall 4 allows the passage of RF signals therethrough. The first room 1 may be a customer facing retail environment, such as a shop floor, for example. The second room 2 may be a non-customer facing store room, for example. One or more RFID tags may be located in the first room 1. One or more RFID tags may be located in the second room 2. For example, RFID tag 8 may be located in the first room 1 in close proximity to the wall 4 dividing the first and second rooms 1, 2. The RFID tags may be affixed to or integrated within respective stock items, such as items of clothing or electronic devices, for example, or affixed to or integrated within the packaging of such stock items. Each of the RFID tags may comprise an encoded unique identifier, such as an electronic product code (EPC). The unique identifier may uniquely identify the stock item corresponding to the RFID tag, for example to distinguish it from other stock items.

The RFID tags may be ultra-high frequency (UHF) RFID tags. The RFID tags may be passive RFID tags which may be detectable by an RFID tag reader 10 by way of radio frequency (RF) signals emitted by the RFID tags. It may be that one or more or each of the RFID tags are passive RFID tags. In this case, it may be that the one or more or each of the RFID tags are not provided with a local power source and that power for the respective RFID tags to emit RF signals to the reader 10 is (e.g. solely) derived from RF trigger signals received by the tags from the reader 10. Alternatively, it may be that one or more or each of the RFID tags are active RFID tags which may comprise a local power source from which the RFID tag can derive power for emitting RF signals to the reader 10. Alternatively, it may be that one or more or each of the RFID tags are semi-active RFID tags which derive some power from RF trigger signals received by the tag from the reader 10 and some power from a local power source.

The RFID tags may be used for stock control and management. In particular, the RFID tag reader 10 may be used to detect the presence of one or more RFID tags, and thus the stock items corresponding to the detected tags, for example by transmitting an RF trigger signal in the vicinity of the tags and receiving corresponding RF signals back from one or more of the tags.

As shown in FIG. 2, the reader 10, which may be a mobile RFID tag reader 10 such as a handheld RFID tag reader 10, may comprise one or more antennas 11 for transmitting RF trigger signals to the RFID tags and for receiving RF signals from RFID tags. If the reader 10 is to detect only active RFID tags for example, it may be that the antennas 11 are not required to send trigger signals to the RFID tags. The reader 10 may further comprise processing circuitry 12 and a memory 13 communicatively coupled to the antennas 11, the processing circuitry 12 being configured to process the signals received from the RFID tags, for example to extract and store data from the received signals, such as the unique identifiers of the detected RFID tags, in order to determine which tags were detected. The signals received from the RFID tag(s) may be time stamped, for example by the processing circuitry 12. The processing circuitry 12 may be further configured to perform stock management operations based on the extracted data, such as creating or updating one or more records, for example in memory 13, of which stock items are present. Time information may also be recorded, for example, in memory 13, to indicate when the last stock count was performed. Further information regarding the stock items corresponding to the detected RFID tags, such as serial numbers or information relating to the product such as sizing information, may also be stored, for example in memory 13. It will be understood that the processing circuitry 12, the memory 13 or the processing circuitry 12 and the memory 13 may alternatively be distributed between the RFID tag reader 10 and one or more computing devices external to the RFID tag reader 10, such as one or more server computers 15 and/or one or more local computing devices (such as one or more local computing devices intermediate the RFID tag reader and one or more server computers 15). The one or more server computers 15 (where provided) may be remote from the reader 10 and may be in communication therewith (or with one or more local computing devices intermediate the reader 10 and the one or more server computers 15) by way of a (e.g. wireless, wired or a combination of wireless and wired) network connection.

It can also be desirable to determine, for example as part of stock control and management operations, a room or floor in which detected tags, and thus the corresponding stock items (where provided), are located. In particular it can be desirable to determine which of first and second tag volumes (such as which of adjacent first and second tag volumes) an RFID tag is located in. For example, in the environment of FIG. 1, it can be desirable to distinguish whether detected RFID tag 8 (and by inference the corresponding stock item, where provided) is located in the first room 1 or the second room 2. This allows for better management of the number of stock items located in the first room 1, for example for customers to browse and purchase, and the number of stock items located in the second room 2, for example for replenishing stock items in the first room 1, and allows tagged stock items to be found more quickly when required.

A first approach to determining a location of an RFID tag, such as determining which of first and second tag volumes a detected RFID tag is located in, is now considered with reference to the RFID tag 8 and the environment of FIG. 1 comprising first and second rooms 1, 2. It may be determined whether the RFID tag 8 is in the first room 1 or the second room 2 by: the reader 10 measuring the received signal strength of an RF signal received from the RFID tag 8 in a single location of room 1 or room 2; comparing the received signal strength to a predetermined threshold; and determining that the tag 8 is in the same room as the reader 10 if the received signal strength is above the threshold and that the tag 8 is in the other room from the reader 10 if the received signal strength is below the threshold. This approach may be valid in some circumstances on the basis that the received signal strength of the RF signal received from the RFID tag may be proportional to the distance between the reader 10 and the tag 8. In this case, the greater the received signal strength, the more likely the tag 8 is located in the same room as the reader 10. However, particularly if the wall 4 separating the first and second rooms 1, 2 is unshielded, it may be that RF signals can pass through the wall 4 (or through the doorway 6) relatively unattenuated. In addition, the signal strength of RF signals received by the reader 10 from the RFID tag 8 may also depend on factors other than the distance between the reader 10 and the tag 8, such as the orientation of the tag 8 relative to the reader 10 (which can affect how much power from the RF trigger signal transmitted by the reader 10 can be used by the RFID tag 8 to generate the RF signal it transmits back to the reader 10 in response) and the presence of any attenuating objects (such as customers, members of staff, items of stock, items of furniture and so on) between the reader 10 and the tag 8. The tag 8 itself can also inherently transmit RF signals of a different strength in response to the same RF signal transmitted by the reader 10 from another similar RFID tag, for example due to manufacturing tolerances of the tags. It may therefore be difficult to accurately predefine a suitable threshold against which to compare the received RF signal strengths. It may thus be difficult to accurately determine which of first and second tag volumes, such as adjacent first and second rooms 1, 2, an RFID tag is located in from a single measurement of received signal strength of an RF signal received from the tag.

A second approach to determining a location of an RFID tag, such as determining which of first and second tag volumes a detected RFID tag is located in, is now considered, again with reference to the RFID tag 8 and the environment of FIG. 1 comprising first and second rooms 1, 2. It may be determined whether the RFID tag 8 is located in the first room 1 or the second room 2 by: the reader 10 measuring the received signal strength of an RF signal received from the RFID tag 8 in a single location of each of room 1 and room 2; and determining that, if the received signal strength when the reader is in the first room 1 is greater than the received signal strength when the reader is in the second room 2, the RFID tag 8 is in the first room 1 and vice versa. This relative comparison approach is generally an improvement on the first approach discussed above as there is no need to define an objective threshold against which to compare the received signal strengths. However, this second approach can also be inaccurate, particularly when the RFID tag is detectable in both the first and second tag volumes, such as when the tag is located close to the boundary between the first and second tag volumes, such as in close proximity to the wall 4 dividing the first and second rooms 1, 2 (e.g. if the wall 4 is unshielded) or the doorway 6 between the first and second rooms 1, 2. In those “fringe” cases, it has been found that the received signal strengths detected by a reader from a tag may be greater when the reader is in a different room from the tag than when the reader is in the same room as the tag. In this case, it would be inaccurate to determine in which of the first and second tag volumes the tag 8 is located based on the room in which the peak signal strength is received.

A further approach to determining a location of an RFID tag, such as determining which of first and second tag volumes a detected RFID tag is located in, is now considered with reference to FIGS. 1-4. An RFID tag reader, such as RFID tag reader 10, may perform RFID tag read operations (e.g. by transmitting RF trigger signals and listening for corresponding RF signals transmitted by RFID tags in response to the trigger signals, although it will be understood that, for example if the RFID tag is an active RFID tag, the tag may transmit RF signals to the reader without having first received a trigger signal from the reader) at each of a first plurality of locations relative to the tag (for example sequentially) to generate first received signal strength data associated with the first tag volume and at each of a second plurality of locations (typically different from the first plurality of locations) relative to the tag (for example sequentially) to generate second received signal strength data associated with the second tag volume. For example, each of the first plurality of locations may be within the first tag volume and each of the second plurality of locations may be within the second tag volume. That is, the first received signal strength data may relate to signals detected from one or more RFID tags at a first plurality of locations within the first tag volume and the second received signal strength data may relate to signals detected from one or more RFID tags at a second plurality of locations within the second tag volume.

The tag read operations may be made by the reader continuously or substantially continuously transmitting trigger signals and listening for responses from the RFID tags. Alternatively, it may be that the tag read operations may be made by the reader transmitting trigger signals with time gaps between them and listening for responses from the RFID tags, for example during the time gaps.

The first and second received signal strength data may be derived by (e.g. the reader, such as processing circuitry 12 of the reader 10) processing RF signals received from the RFID tag by the one or more antennas 11, for example to measure the received signal strength of the RF signals received from the RFID tag. The processing circuitry 12 may further extract the unique identifier of the RFID tag from the RF signals received therefrom and associate the unique identifier with the received signal strengths. The first received signal strength data may thus comprise received signal strengths of RF signals received from an RFID tag (e.g. in response to RF trigger signals transmitted by the reader) at one or more or each of the first plurality of locations. The second received signal strength data may comprise received signal strengths of RF signals received from the RFID tag (e.g. in response to RF trigger signals transmitted by the reader) at one or more or each of the second plurality of locations. The first and second received signal strength data may comprise or be associated with the unique identifier of the RFID tag.

The received signal strengths may be normalised. For example, for a given RFID tag reader, the received signal strengths may be divided by a maximum signal strength received by the reader during that reading operation (or by a maximum received signal strength by the reader during reading for a particular room or store layout, for example). Received signal strength can depend on factors such as available battery power in the RFID reader. Normalising the received signal strength values takes such factors into account and allows received signal strengths by the same reader at different times (as well as received signal strengths by different readers) to be compared more reliably with each other.

The first and second received signal strength data may further comprise time stamps (which may be provided by the reader 10) associated with when the signals associated with the respective received signal strengths in the first and second received signal strength data were received by the reader. The time stamps may be normalised. For example, the time stamps may be normalised to extend between a scale of 0% to 100%. By normalising the time stamps, differences in how time may be recorded can be accounted for.

The acquisition of the first and second received signal strength data may be illustrated with reference to the RFID tag 8 and the environment of FIG. 1 comprising the first and second rooms 1, 2. The first plurality of locations relative to the tag 8 in this case may be a first plurality of locations 20-28 within the first room 1 and the second plurality of locations relative to the tag 8 may be a second plurality of locations 30-38 within the second room 2. The locations 20-28 may be distributed throughout the first room 1 and the locations 30-38 may be distributed throughout the second room 2. The locations 20-28 of the first room 1 may comprise areas of the first room 1 known or suspected to contain RFID tags, such as areas of the first room 1 containing shelves, racks or other types of product display. The locations 30-38 of the second room 2 may comprise areas of the second room known or suspected to contain RFID tags, such as areas of the second room 2 where containers (e.g. boxes) of tagged products are stored or shelves or racks storing tagged products. The reader, such as the reader 10, may perform RFID tag read operations sequentially at locations in the order of locations 20, 22, 24, 26 then 28 in the first room and sequentially at locations in the order of locations 30, 32, 34, 36 then 38 in the second room as indicated by the arrows of FIG. 1. The measurements may be made in the first room 1 before those in the second room 2 or vice versa, such as by the same reader (e.g. reader 10). Alternatively the measurements may be made in the first and second room 1, 2 generally at the same time by different readers, such as readers 10. The RFID tag 8 may remain static during the RFID tag operations 20-28, 30-38.

The user may provide an input to the reader 10 to indicate the tag volume in respect of which the readings are being performed, for example before, during or after the first and second received signal strength data is acquired at locations 20-28 and 30-38. This tag volume information may be comprised in or associated with the first and second received signal strength data.

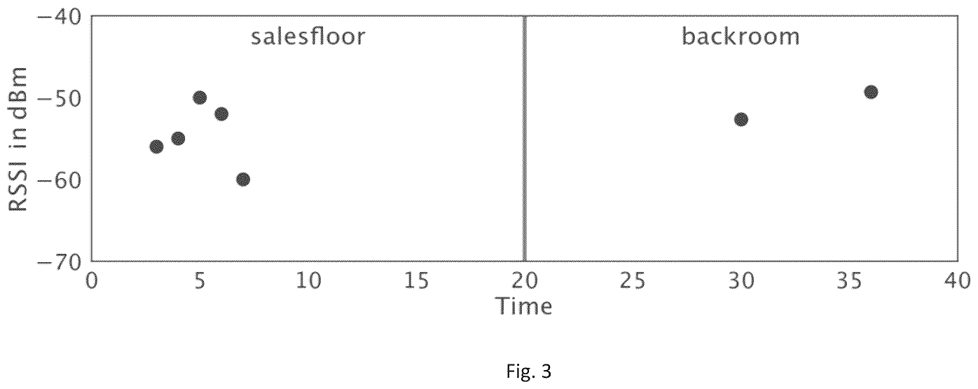

In the example of FIG. 1, the first received signal strength data may comprise (e.g. time-stamped) received signal strengths of RF signals received from the RFID tag 8 (e.g. in response to RF trigger signals transmitted by the reader 10) at one or more of the first plurality of locations 20-28 within the first room 1. The second received signal strength data may comprise (e.g. time-stamped) received signal strengths of RF signals received from the RFID tag 8 (e.g. in response to RF trigger signals transmitted by the reader 10) at one or more of the second plurality of locations 30-38 within the second room 2. FIG. 3 shows example received signal strengths of RF signals received from the RFID tag 8 by the reader 10 at the five locations 20-28 of the first room 1 and at the first and fifth locations 30, 38 of the five locations 30-38 of the second room 2. No signals were detected from the RFID tag 8 by the reader 10 at the second to fourth locations 32-36 of the reader 10 in the second room 2 in this example. The x-axis of FIG. 3 is time, indicating that the RFID tag readings were performed sequentially in time, with the attempted tag readings at the five locations 20-28 of the first room 1 being performed between 0 and 10 seconds, with the attempted tag readings at the five locations 30-38 of the second room 2 being performed between 25 and 40 seconds. A vertical line is provided at 20 seconds to indicate the time at which the reader 10 crossed from the first room 1 to the second room 2.

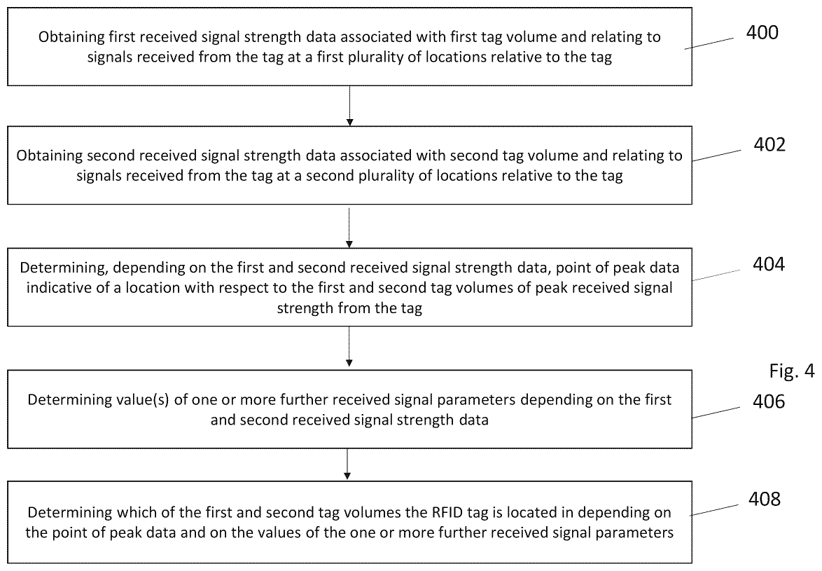

The first and second received signal strength data may be processed to determine which of the first and second tag volumes, such as which of the first and second rooms 1, 2, the tag (such as tag 8) is located in. FIG. 4 is a flow chart illustrating an example method of determining the location of the RFID tag based on the first and second received signal strength data. The method of FIG. 4 may be performed by processing circuitry 12 of the reader 10, or by processing circuitry of one or more computing devices external to the reader 10 (such as one or more server computers 15 and/or one or more local computers, which may be in communication with the reader 10 so as to receive therefrom the first and second signal strength data or data from which it can be derived) or partially by the processing circuitry 12 of the reader 10 and partially by processing circuitry of one or more computing devices (such as one or more servers 15 and/or one or more local computers) external to the reader 10. The processing circuitry may be configured to implement the method of FIG. 4 by executing computer program instructions (i.e. in software), in hardware, in firmware or in any combination thereof. Memory may be provided for storing the computer program instructions, the processing circuitry being in communication with said memory in order to retrieve the computer program instructions therefrom.

At 400 and 402, the first and second received signal strength data is obtained, for example by processing circuitry of the reader 10 or one or more external computing devices, for example by the processing circuitry retrieving the first and second received signal strength data from memory or by the external computing device(s) receiving the first and second received signal strength data from the reader. The first and second received signal strength data may comprise time stamped received signal strengths of signals received at the respective first and second pluralities of locations relative to the tag.

At 404, point of peak data indicative of a location of peak received signal strength from the tag with respect to the first and second tag volumes may be determined depending on the first and second received signal strength data, for example by the said processing circuitry. The point of peak data may be indicative of whether the location of peak received signal strength from the tag is, or is associated with, the first tag volume (e.g. whether the location of peak received signal strength from the tag is the first room 1 in the example of FIG. 1) or is, or is associated with, the second tag volume (e.g. whether the location of peak received signal strength from the tag is the second room 2 in the example of FIG. 1).

The point of peak data indicative of the location of peak received signal strength from the tag with respect to the first and second tag volumes may comprise time data relating to a time at which the signal having the peak received signal strength was received. In this case, the point of peak data may be determined by determining time data, for example based on (e.g. normalised) time stamp data from the first and second received signal strength data, relating to a time at which a signal having the peak signal strength of the first and second received signal strength data was received from the tag. In this case, it may be that the same reader is used to sequentially determine the first received signal strengths associated with the first tag volume at the first plurality of locations relative to the tag and the second received signal strengths associated with the second tag volume at the second plurality of locations relative to the tag, such that the time data relating to the time at which the peak signal strength was detected is indicative of the location with respect to the first and second tag volumes at which the peak signal strength was detected (such as in the example of FIG. 3). For example, earlier time data may indicate that the location of peak signal strength is associated with the first tag volume (e.g. the location of peak signal strength is in the first room 1), while later time data may indicate that the location of peak signal strength is associated with the second tag volume (e.g. the location of peak signal strength is in the second room 2). Whether the location of peak signal strength is associated with the first or second tag volume may be indicative of whether the tag is more likely to be in the first tag volume or the second tag volume.

It will be understood that similar results may be obtained if the signals at the first and second pluralities of locations relative to the tag were detected by different readers, for example by applying a time offset to the time stamps of the first or second received signal strength data, and then determining the (e.g. normalised) time (including the time offset, where applied) at which the peak received signal strength of the first and second received signal strength data was recorded.

Additionally or alternatively, the point of peak data may be determined by determining which of the first and second received signal strength data contains the peak received signal strength from the tag. If the first received signal strength data contains the peak received signal strength from the tag, it may be determined that the location of peak received signal strength is associated with (e.g. is in) the first tag volume. This may be indicative that the tag is more likely to be located in the first tag volume. If the second received signal strength data contains the peak received signal strength from the tag, it may be determined that the location of peak received signal strength from the tag is associated with (e.g. is in) the second tag volume. This may be indicative that the tag is more likely to be located in the second tag volume. As mentioned above, the first and second received signal strength data may be associated with the first and second tag volumes by way of operator input.

It can be seen from FIG. 3 that, in the illustrated example, the peak (or maximum) signal strength was detected by the reader 10 from the RFID tag 8 at the fifth location 38 of the second room 2 near the doorway 6 between the first and second rooms 1, 2, despite the fact that the RFID tag 8 is located in the first room 1. Accordingly, determining whether the RFID tag 8 is located in the first room 1 or the second room 2 solely from point of peak data relating to the determined location of maximum signal strength detection would be inaccurate in this case. At 406, value(s) of one or more further received signal parameters may be determined depending on the first and second received signal strength data. It may be that the value(s) of one or more or each of the one or more further received signal parameters depend on a plurality of data points of the first received signal strength data, a plurality of data points of the second received signal strength data or a plurality of data points of each of the first and second received signal strength data. The data points may relate to (e.g. comprise) received signal strengths or time stamped received signal strengths. The values of the one or more further received signal parameters may facilitate (e.g. direct or indirect) comparison of the first and second received signal strength data to thereby help determine which tag volume the tag is located in, for example in combination with the point of peak data.

It may be that each of the one or more further received signal parameters relates to (e.g. is indicative of) a feature of the first received signal strength data, a feature of the second received signal strength data, a feature of the combination of the first and second received signal strength data or a comparison of corresponding features of the first and second received signal strength data. For example, the one or more further received signal parameters may comprise any one or more (e.g. any two or more) of: one or more further received signal parameters selectively based on the first received signal strength data (e.g. but not on the second received signal strength data); one or more further received signal parameters selectively based on the second received signal strength data (e.g. but not on the first received signal strength data); one or more further received signal parameters based on the combination of the first and second received signal strength data.

The one or more further received signal parameters may comprise a plurality of received signal parameters. It may be that the said plurality of received signal parameters comprise a plurality of different received signal parameters. The plurality of received signal parameters may relate to a plurality of different features of the first received signal strength data and a corresponding plurality of features of the second received signal strength data. The plurality of received signal parameters may allow features specifically of the first received signal strength data and (e.g. corresponding) features specifically of the second received signal strength data to be taken into account in the determination of which of the first and second tag volumes the tag is more likely to be located in. The features of the received signal strength data may comprise any one or more of: a number of reads of the tag; a number of reads of the tag per unit time; an average received signal strength of signals received from the tag; a variation of received signal strengths of signals received from the tag; a time or location at which a peak received signal strength was received from the tag; a peak signal strength of signals received from the tag.

The one or more further received signal parameters may comprise any one or more of: one or more (e.g. a plurality of different) received signal parameters selectively based on the first received signal strength data and one or more corresponding received signal parameters selectively based on the second received signal strength data; one or more (e.g. a plurality of different) received signal parameters selectively based on the first received signal strength data and one or more corresponding received signal parameters based on the combination of the first and second received signal strength data; one or more (e.g. a plurality of different) received signal parameters selectively based on the first received signal strength data, one or more corresponding received signal parameters selectively based on the second received signal strength data and one or more corresponding received signal parameters based on the combination of the first and second received signal strength data. By determining which of the tag volumes the tag is located in depending on values of a plurality of received signal parameters, the accuracy of the determination of the tag's location may be further improved.

The one or more further received signal parameters may comprise one or more comparative received signal parameters, each of the one or more comparative received signal parameters being based on a respective comparison of (e.g. corresponding features of) the first and second received signal strength data. For example, a value of a comparative received signal parameter may indicate whether a value of a parameter relating to a feature of the first received signal strength data is greater or less than the value of a corresponding parameter relating to a corresponding feature of the second received signal strength data. Additionally or alternatively, a comparative received signal parameter may indicate the extent of a difference between values of corresponding parameters relating to corresponding features of the respective first and second received signal data. In some examples, the one or more further received signal parameters may comprise a plurality of different comparative received signal parameters each based on a different respective comparison (e.g. a comparison of different corresponding features) of the first and second received signal strength data.

It will be understood that corresponding parameters based on different data sets (e.g. the first received signal strength data, the second received signal strength data or the first and second received signal strength data), or corresponding features of different data sets, may be the same or similar parameters based on the different data sets or the same or similar features of the different data sets. For example, corresponding parameters or features may be directly or indirectly comparable.

The one or more further received signal parameters may comprise one or more read count parameters relating to a number of reads of the tag or a number of reads of the tag per unit time. For example, the one or more further received signal parameters may comprise any one or more of: one or more read count parameters relating to (e.g. indicative of) a number of reads of the tag or a number of reads of the tag per unit time (e.g. selectively) based on the first received signal strength data; one or more read count parameters relating to (e.g. indicative of) a number of reads of the tag or a number of reads of the tag per unit time (e.g. selectively) based on the second received signal strength data; one or more read count parameters relating to (e.g. indicative of) a number of reads of the tag or a number of reads of the tag per unit time based on a combination of the first and second received signal strength data. Additionally or alternatively, the one or more further received signal parameters may comprise one or more further received signal parameters relating to (e.g. indicative of) a comparison of a number of reads of the tag or a number of reads of the tag per unit time (e.g. selectively) based on the first received signal strength data and a number of reads of the tag or a number of reads of the tag per unit time (e.g. selectively) based on the second received signal strength data, such as an indication of which of the first and second received signal strength data comprises a greater read count of the tag (or a greater read count per unit time) or the extent of the difference between the read count (or read count per unit time) of the tag (e.g. selectively) based on the first received signal strength data and the read count (or read count per unit time) of the tag (e.g. selectively) based on the second received signal strength data. Values of parameters relating to a read count per unit time may be determined based on the time stamps of the respective received signal strength data. It may be that zero or null received signal strengths (or received signal strengths below some other predefined threshold), such as the attempted reads at the second to fourth locations 32, 34, 36 in the example of FIG. 1, are not considered to be “reads” when determining the read count parameters.

It can be seen in FIG. 3 that although the peak signal strength is in the second received signal strength data associated with the second room 2, there are more reads of the RFID tag 8 in the first received signal strength data associated with the first room 1 than in the second received signal strength data associated with the second room 2. There are also more reads of the RFID tag 8 per unit time of the RFID tag 8 in the first received signal strength data associated with the first room 1 than in the second received signal strength data associated with the second room 2. It has been found that a cluster of detections of an RFID tag is a strong indicator that the tag is located in that tag volume. In this case, clusters may be considered to be a relatively large number of reads of the tag in a relatively short space of time. The greater the read count (or the greater the read count per unit time) in the first received signal strength data relative to the second received signal strength data, the greater the probability that the tag is located in the first tag volume and vice versa. Accordingly, the determined values of the read count parameter(s) may provide a further indicator of the tag volume in which the tag is located.

Additionally or alternatively, the one or more further received signal parameters may comprise one or more average received signal strength parameters relating to an average (e.g. mean or median) received signal strength of signals received from the tag. For example, the one or more further received signal parameters may comprise any one or more of: one or more average received signal strength parameters relating to (e.g. indicative of) an average (e.g. mean or median) received signal strength of signals received from the tag (e.g. selectively) based on the first received signal strength data; one or more average received signal strength parameters relating to (e.g. indicative of) an average (e.g. mean or median) received signal strength of signals received from the tag (e.g. selectively) based on the second received signal strength data; one or more average received signal strength parameters relating to (e.g. indicative of) an average (e.g. mean or median) received signal strength of signals received from the tag based on the combination of the first and second received signal strength data. Additionally or alternatively, the one or more further received signal parameters may comprise one or more further received signal parameters relating to (e.g. indicative of) a comparison of an average (e.g. mean or median) received signal strength of signals received from the tag (e.g. selectively) based on the first received signal strength data and an average (e.g. mean or median) received signal strength of signals received from the tag (e.g. selectively) based on the second received signal strength data, such as an indication of which of the first and second received signal strength data relates to a greater average received signal strength from the tag or an extent of a difference between an average (e.g. mean or median) received signal strength (e.g. selectively) based on the first received signal strength data and an average (e.g. mean or median) received signal strength (e.g. selectively based on) the second received signal strength data.

It may be that the average received signal strength parameters are determined taking into account attempted detections in which no RF signal was received from the RFID tag. For example, in the determination of an average signal strength parameter based on the second received signal strength data of FIG. 3, it may be that the zero signal strength readings at the second to fourth locations 32, 34, 36 within the second room 2 are included. For example, with reference to the first and second signal strength data shown in FIG. 3, the average received signal strength in the first room 1 is greater than the average received signal strength in the second room 2, the zero readings of the second room 2 bringing the average received signal strength down below that of the first room 1. In a similar way to the read count parameters discussed above, it has been discovered that average received signal strength of the first and second received signal strength data is a strong indicator of whether the tag is located in the first tag volume or the second tag volume. Accordingly, one or more average signal strength parameters based on the first and second received signal strength data may provide a further indicator of the tag volume in which the tag is located.

Additionally or alternatively, the one or more further received signal parameters may comprise one or more parameters relating to a variation of received signal strengths of signals received from the tag. For example, the one or more received signal parameters may relate to a difference between maximum and minimum received signal strengths or a standard deviation of received signal strengths, or any other suitable such parameter. The one or more received signal parameters may comprise any one or more of: one or more parameters relating to (e.g. indicative of) a variation of received signal strengths of signals received from the tag (e.g. selectively) based on the first received signal strength data; one or more parameters relating to (e.g. indicative of) a variation of received signal strengths of signals received from the tag (e.g. selectively) based on the second received signal strength data; one or more parameters relating to (e.g. indicative of) a variation of received signal strengths of signals received from the tag based on the combination of the first and second received signal strength data. Additionally or alternatively, the one or more further received signal parameters may comprise one or more further received signal parameters relating to (e.g. indicative of) a comparison of a variation of received signal strengths of signals received from the tag (e.g. selectively) based on the first received signal strength data and the variation of received signal strengths of signals received from the tag (e.g. selectively) based on the second received signal strength data, such as an indication of which of the first and second received signal strength data has the greater variation in received signal strength or the extent of the difference in variation in received signal strength (e.g. selectively) based on the first received signal strength data and the variation in received signal strength (e.g. selectively) based on the second received signal strength data.

It may be that values of the parameters indicative of the variation of the received signal strength are determined taking into account attempted detections in which no RF signal was received from the RFID tag. For example, in the determination of a parameter relating to the variation of the received signal strength based on the second received signal strength data of FIG. 3, it may be that the zero signal strength readings at the second to fourth locations 32, 34, 36 within the second room 2 are included. It can thus be derived from the first and second signal strength data shown in FIG. 3 that there is more variation between received signal strengths in the second received signal strength data detected in the second room 2 than between the received signal strengths in the first received signal strength data detected in the first room 1, the zero readings of the second room 2 increasing the variation in signal strengths above that of the first room 1.

Other parameters relating to the variation of received signal strengths which may be determined include any one or more of: one or more parameters based on an absolute sum of changes between received signal strength values (e.g. a parameter relating to or indicative of the sum of differences between subsequent received signal strength values); one or more parameters relating to or indicative of a read count (or read count per unit time) of readings having received signal strengths above the average (e.g. mean or median) received signal strength; one or more parameters relating to or indicative of a read count (or read count per unit time) of readings having received signal strengths below the average (e.g. mean or median) received signal strength; one or more parameters relating to or indicative of a number of equal valued received signal strength maxima (e.g. measured to zero decimal places); one or more parameters relating to or indicative of a sum of received signal strength values. As above, it may be that zero readings are taken into account in the determination of these parameters.

Additionally or alternatively, the one or more further received signal parameters may comprise one or more determined read quality parameters relating to the determined read quality of signals received from the tag. For example, the one or more further received signal parameters may comprise any one or more of: one or more determined read quality parameters relating to (e.g. indicative of) a determined read quality of signals received from the tag (e.g. selectively) based on the first received signal strength data; one or more determined read quality parameters relating to (e.g. indicative of) a determined read quality of signals received from the tag (e.g. selectively) based on the second received signal strength data; one or more determined read quality parameters relating to (e.g. indicative of) a determined read quality of signals received from the tag based on a combination of the first and second received signal strength data. Additionally or alternatively, the one or more further received signal parameters may comprise one or more further received signal parameters relating to (e.g. indicative of) a comparison of a determined read quality of signals received from the tag (e.g. selectively) based on the first received signal strength data and a determined read quality of signals received from the tag (e.g. selectively) based on the second received signal strength data, such as an indication of which of the first and second received signal strength data comprises a better tag read quality or an extent of a difference between a tag read quality (e.g. selectively) based on the first received signal strength data and a tag read quality (e.g. selectively) based on the second received signal strength data.

Received signal strength data having a relatively low number of read events with relatively largely varying signal strength values may indicate a relatively low average read quality (and thus a relatively low confidence level that the tag is located in the tag volume associated with that received signal strength data). Accordingly, the values of the determined read quality parameters may be determined, for example, depending on any one or more of: respective read counts of the tag in the respective first and second received signal strength data; average received signal strengths of signals received from the tag in the respective first and second received signal strength data; variations of received signal strengths in the respective first and second received signal strength data.

Additionally or alternatively, the one or more further received signal parameters may comprise one or more parameters relating to a time or location at which a peak received signal strength was received from the tag. For example, the one or more further received signal parameters may comprise any one or more of: one or more parameters relating to (e.g. indicative of) a time or location at which a peak received signal strength was received from the tag (e.g. selectively) based on the first received signal strength data; one or more parameters relating to (e.g. indicative of) a time or location at which a peak received signal strength was received from the tag (e.g. selectively) based on the second received signal strength data; one or more parameters relating to (e.g. indicative of) a time or location at which a peak received signal strength was received from the tag based on a combination of the first and second received signal strength data.

For example, in the example of FIG. 1, the fifth location 38 within the second room 2 is in close proximity to the wall 4 and to the doorway 6. It may be that, with the reader 10 located in the second room in close proximity to the doorway 6 or the wall 4 (or both the doorway 6 and the wall 4), the likelihood is increased that an RF signal from the tag 8 located in the first room 1 would be received by the reader 10 with a relatively high received signal strength compared to if the reader 10 is located at a different position within the second room further from the first room 1. Similarly, if the peak received signal strength in the first room 1 was detected at a location not in close proximity to the wall 4 or the doorway 6, this can increase the likelihood that the RFID tag 8 is located in the first room 1 even if the peak received signal strength was detected in the second room 2. Thus, the parameters indicative of a time or location at which the peak signal strengths were received can be taken into account to determine which of the first and second rooms 1, 2 the tag 8 is located in with greater accuracy.

As discussed above, a user/operator may provide an input to the reader 10 to indicate the tag volume in respect of which the readings are performed. It may therefore be known when the user (and thus the reader) switches between the first and second rooms 1, 2. The readings within the rooms may also be time stamped. Accordingly, it can be determined when the user is at the beginning and end of a scan of each the first and second rooms 1, 2. In the example above, it can thus be determined that the reader 10 was at the fifth (e.g. final) location 38 in the second room 2 when a specific tag reading was made based on the time stamp information associated with the received signal strength data and the indication of the tag volume in respect of which readings were performed. Thus, if a parameter relating to a time at which a peak received signal strength was received from the tag indicates that the peak received signal strength was received at, for example, the end of a scan, it may be indicative that the measurement occurred in close proximity to the other tag volume, indicating that the point of peak may be a less reliable indicator of the location of the tag.

It will also be understood that the reader 10 may be in close proximity to the doorway 6 or the wall 4 (or both the doorway 6 and the wall 4) when the reader 10 switches between the first and second rooms 1, 2. Thus, a peak signal strength detected in the first or second rooms 1, 2 shortly before or after the reader 10 has switched between the first and second rooms 1, 2 is likely to have been obtained in close proximity to the doorway 6 or the wall 4 (or both the doorway 6 and the wall 4). Thus, if a parameter relating to a time at which a peak received signal strength was received from the tag indicates a time shortly before or shortly after the reader 10 switched between the first and second rooms 1, 2, it may be indicative that the point of peak is a less reliable indicator of the location of the tag.

Additionally or alternatively, the one or more further received signal parameters may comprise one or more further received signal parameters relating to (e.g. indicative of) a comparison of a time or location at which a peak received signal strength was received from the tag (e.g. selectively) based on the first received signal strength data and a time or location at which a peak received signal strength was received from the tag (e.g. selectively) based on the second received signal strength data, such as an indication of which of the first and second received signal strength data comprises a peak received signal strength at a time or location closer to a time or location at which the reader switched between acquiring the first and second received signal strength data (e.g. when the reader switched tag volumes) or an extent to which one of the times or locations was closer to the time or location at which the reader switched between acquiring the first and second received signal strength data.

Additionally or alternatively, the one or more further received signal parameters may comprise one or more signal strength parameters relating to a peak signal strength of signals received from the tag. For example, the one or more further received signal parameters may comprise any one or more of: one or more signal strength parameters relating to (e.g. indicative of) a peak signal strength received from the tag (e.g. selectively) based on the first received signal strength data; one or more signal strength parameters relating to (e.g. indicative of) a peak signal strength received from the tag (e.g. selectively) based on the second received signal strength data; one or more signal strength parameters relating to (e.g. indicative of) a peak signal strength received from the tag based on a combination of the first and second received signal strength data. Additionally or alternatively, the one or more further received signal parameters may comprise one or more further received signal parameters relating to (e.g. indicative of) a comparison of the peak signal strength received from the tag (e.g. selectively) based on the first received signal strength data and the peak signal strength received from the tag (e.g. selectively) based on the second received signal strength data, such as an indication of the extent of the difference between the peak signal strength received from the tag (e.g. selectively) based on the first received signal strength data and the peak signal strength received from the tag (e.g. selectively) based on the second received signal strength data.

Referring to the example of FIG. 3, it can be seen that the difference in the peak received signal strength of the first received signal strength data and the peak received signal strength of the second received signal strength data is relatively small. This is indicative that the peak received signal strength of the combined first and second signal strength data being in the second signal strength data is a relatively weak indicator that the tag 8 is located in the second room 2 (which, as discussed, it is not in this example, the tag 8 being located in the first room 1). Thus, this information can be used to determine the tag volume (e.g. the room of rooms 1, 2) in which the tag is located with greater accuracy.

Additionally or alternatively, the one or more further received signal parameters may comprise one or more parameters relating to a time between tag reads. For example, the one or more further received signal parameters may comprise any one or more of: one or more parameters relating to (e.g. indicative of) a time between tag reads (e.g. selectively) based on the first received signal strength data; one or more parameters relating to (e.g. indicative of) a time between tag reads (e.g. selectively) based on the second received signal strength data; one or more parameters relating to (e.g. indicative of) a time between tag reads based on a combination of the first and second received signal strength data. For example, the parameters relating to the time between tag reads may be based on average (e.g. mean or median) times between tag reads, or standard deviations of times between tag reads, or any other suitable parameter. Additionally or alternatively, the one or more further received signal parameters may comprise one or more further received signal parameters relating to (e.g. indicative of) a comparison of the time between tag reads (e.g. selectively) based on the first received signal strength data and the time between tag reads (e.g. selectively) based on the second received signal strength data, such as an indication of which of the first and second received signal strength data comprises a greater average (e.g. mean or median) time between tag reads or the extent of the difference between the average time between tag reads (e.g. selectively) based on the first received signal strength data and the average time between tag reads (e.g. selectively) based on the second received signal strength data.

It can be seen from the example of FIG. 3 that the time between reads is greater in the second received signal strength data than in the first received signal strength data. In this case, it will be understood that zero or null received signal strengths (or received signal strengths below some other predefined threshold), such as the attempted reads at the second to fourth locations 32, 34, 36 in the example of FIG. 1, may not be considered to be “reads” in this case.

The one or more further received signal parameters may comprise any one or more of, or any combination of, the further received signal parameters discussed herein.

When values of corresponding parameters are determined both selectively based on the first received signal strength data and selectively based on the second received signal strength data, values of (e.g. corresponding) parameters may also still be extracted from the combination of the first and second received signal strength data at least because values of such parameters provide context (e.g. indications of general quality of the readings from the tags) which can help to improve the accuracy of the determination of which of the first and second tag volumes the tag is located in.

At 408, the method may comprise determining which of the first and second tag volumes the RFID tag is located in depending on the point of peak data and on the determined values of the one or more further received signal parameters, such as one or more of the example further received signal parameters discussed above.

It may be that the point of peak data is indicative that the location of peak received signal strength from the tag is associated with one of the first and second tag volumes. Depending on the determined values of the one or more further received signal parameters, it may be determined that the tag is located in the same or a different tag volume from the tag volume associated with the location of peak received signal strength from the tag. It may be determined that the tag is located in a different tag volume (e.g. of the first and second tag volumes) from tag volume (e.g. of the first and second tag volumes) associated with the location of peak received signal strength from the tag depending on determined values of a plurality (e.g. two or more or three or more) of the (e.g. different) further received signal parameters (e.g. further received signal parameters based on a plurality of different features of the first received signal strength data and on a corresponding plurality of features of the second received signal strength data). For example, it may be that the determined values of the plurality (e.g. two or more or three or more) of further received signal parameters are indicative that the tag is in the said different tag volume from the tag volume associated with the location of peak received signal strength from the tag.

Taking into account value(s) of one or more further received signal parameters based on the first and second received signal strength data, in combination with the point of peak data, has been found to provide an improvement in accuracy over the use of the determination of which of the first and second received signal strength data comprises the greatest signal strength data alone, particularly for “fringe” cases where the tag is detectable in both the first and second tag volumes, such as when the tag is located near a boundary between the first and second tag volumes.

By the point of peak data and the one or more further received signal parameters depending on the first and second received signal strength data, which relate to signals received from the tag at respective pluralities of locations relative to the tag, errors which can occur in the determination of the location of the tag can be reduced. For example, the effect on the determination of the location of the tag of received signal strengths from the tag being reduced by unfavourable orientations of the tag relative to the relevant RFID reader can be mitigated by the reader receiving RF signals from the RFID tag at different locations because the reader may detect signals from the RFID tag at different relative orientations of the reader and the tag at the different locations. This helps to provide a more accurate determination of which of the first and second tag volumes the tag is located in.

The determination as to which of the first and second tag volumes the RFID tag is located in can be performed in a number of different ways. For example, input data may be determined based on the point of peak data and the value(s) of the one or more further received signal parameters and the input data may be compared to (e.g. empirically based) predetermined reference data to determine which of the first and second tag volumes the tag is located in. It may be that the predetermined reference data relates the point of peak data and the values of the one or more further received signal parameters to a tag volume in which the RFID tag may be located.

In some examples, the point of peak data and the determined values of the one or more further received signal parameters are taken into account at 408 in order to determine which of the first and second tag volumes the tag is located in by causing input data based thereon to be input (e.g. inputting input data based thereon) to a trained machine learning model. The input data may further comprise the time stamped received signal strengths of the first and second received signal strength data. The trained machine learning model may determine which of the tag volumes the tag is more likely to be located in based on the input data and the trained machine learning model itself. An indication may then be obtained from the trained machine learning model as to which of the first and second tag volumes the tag is more likely to be located in. A probability with which the tag is located in that volume may also be provided by the trained machine learning model.

The point of peak data and the further received signal parameters discussed herein are strong indicators of whether the tag is more likely to be located in the first tag volume or in the second tag volume. Accordingly, use of these parameters helps to provide reliable results with the computing effort kept within reasonable limits.

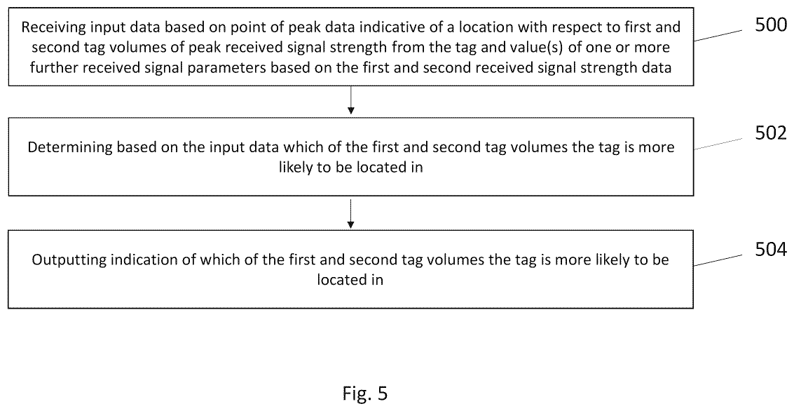

An example method of determining which of the first and second tag volumes the tag is located in using a trained machine learning model is illustrated by the flowchart of FIG. 5. As above, the method of FIG. 5 may be performed by the processing circuitry of the reader, by processing circuitry of one or more external computing devices (such as by one or more servers 15) or partially by processing circuitry of the reader and partially by processing circuitry of one or more external computing devices. The processing circuitry may be configured to implement the method of FIG. 5 by executing computer program instructions (i.e. in software), in hardware, in firmware or in any combination thereof. Memory may be provided for storing the computer program instructions, the processing circuitry being in communication with said memory in order to retrieve the computer program instructions therefrom. The trained machine learning model may be stored at the reader, in one or more computing devices external to the reader (such as in one or more servers 15) or partially in the reader and partially in the one or more computing devices (such as in one or more servers 15) external to the reader.

At 500, the method may comprise the trained machine learning model receiving input data based on (e.g. the input data may comprise) point of peak data indicative of a location with respect to first and second tag volumes of peak received signal strength from the tag and values of one or more further received signal parameters based on the first and second received signal strength data, such as one or more of the further received signal parameters discussed above.

At 502, the trained machine learning model may determine whether the tag is more likely to be located in the first tag volume or the second tag volume based on the input data, for example by classifying the input data. At 504, the trained machine learning model may output an indication of which of the first and second tag volumes the tag is more likely to be located in. The machine learning model may output an indication of which of the first and second tag volumes the tag is more likely to be located in may be output to a user interface, for example, by outputting a probability with which the tag is located in that tag volume.

The machine learning model may be trained based on one or more training data sets, each of the one or more training data sets being based on a known one of first and second training tag volumes in which an RFID tag is located, point of peak data indicative of a location with respect to first and second training tag volumes of peak received signal strength from the RFID tag and training value(s) of the one or more further received signal parameters. The said point of peak data and training values of said parameter(s) may be based on first and second received signal strength training data, the first received signal strength training data being associated with the first training tag volume and relating to signals received from the tag at a first plurality of locations relative to the tag and the second received signal strength training data associated with the second training tag volume (e.g. adjacent to the first training tag volume) and relating to signals received from the tag at a second plurality of locations relative to the tag. The training data sets may further comprise all of the time stamped received signal strengths of the first and second received signal strength data. Training is discussed in more detail below.

The trained machine learning model may be of any suitable type of trained machine learning model. The trained machine learning model may be a supervised learning model. For example, the trained machine learning model may be any of: a trained Bayesian network model such as a Naïve Bayes classifier; a logistic regression classifier; a support vector machine classifier; a decision tree such as a gradient boosted decision tree classifier. A gradient boosted decision tree is a decision tree determined from a plurality of sequentially connected decision trees, each subsequent decision tree focussing on correcting errors from the previous tree in the sequence to create a boosted decision tree which aggregates the results from all of the trees in the sequence to produce a stronger overall classifier.

In each case, the trained machine learning model may receive the input data and determine which of the first and second tag volumes the tag is more likely to be located in depending on the input data and the trained model itself.

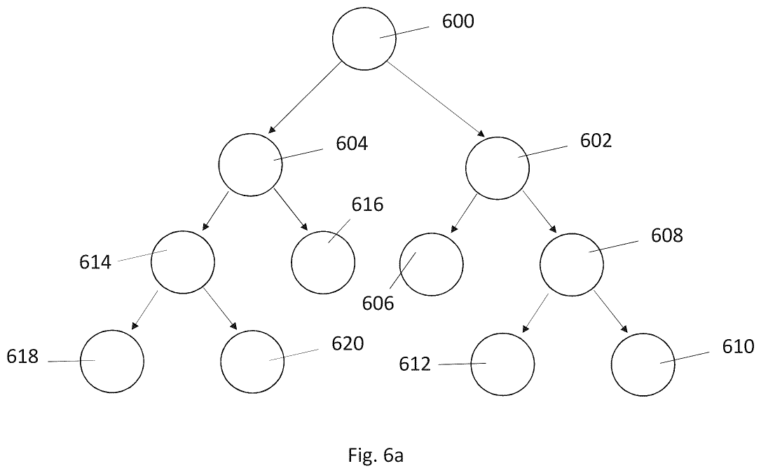

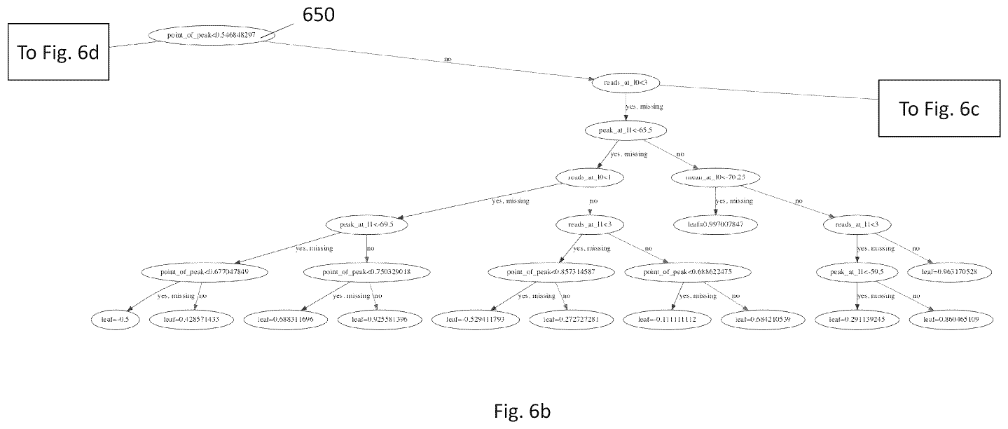

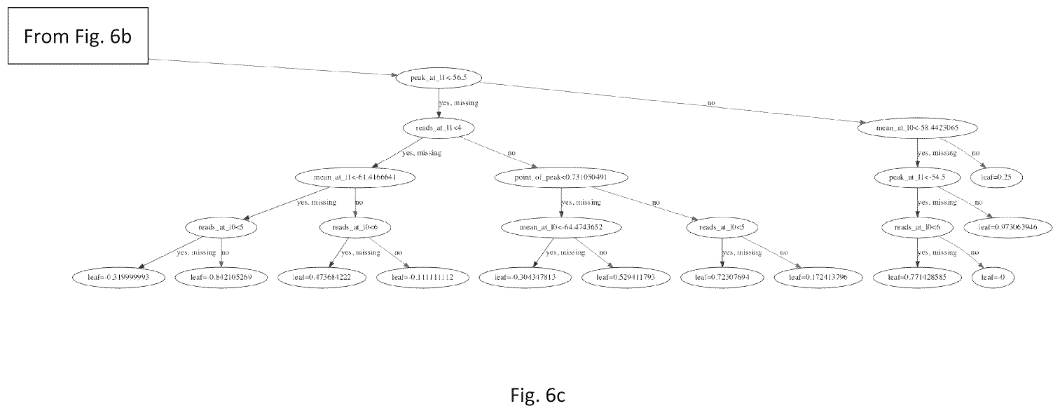

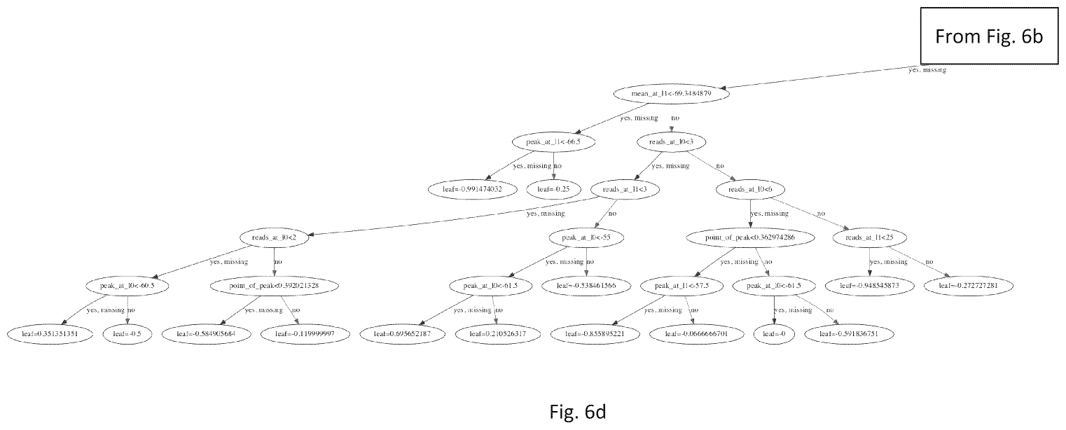

An example decision tree is illustrated in FIG. 6a. Each node of the decision tree represents a decision point apart from the last (leaf) nodes in each branch which represent classification decisions. The decision tree training process may determine that the point of peak data is the highest priority classification parameter. The root node of the decision tree may thus be based on the said point of peak data. The decision tree of FIG. 6 may be configured such that if, at the root node 600, a decision is made based on the input data that the location of peak received signal strength from the tag is associated with the first tag volume (e.g. the first room 1), then the decision tree moves on to node 602, otherwise the decision tree moves onto node 604.

The second level of the decision tree (which may relate to the second highest priority classification) may be based on one or more read count parameters relating to a number of reads of the tag (e.g. respective parameters indicating the respective read counts in the first and second received signal strength data or a comparative parameter indicating whether the first or second received signal strength data has the greater read count). The decision tree may be configured such that if, at node 602, a decision is made that the read count of the first received signal strength data is greater than or equal to read count of second received signal strength data, then the decision tree moves onto node 606. If the read count of the first received signal strength data is determined to be less than the read count of second received signal strength data, then the decision tree moves onto node 608. Node 606 may be a leaf node indicating that the tag is in the first tag volume (e.g. the first room 1).

The decision tree may be further configured such that if, at node 604, a decision is made that the read count of the second received signal strength data is greater than or equal to read count of first received signal strength data, then the decision tree moves onto node 616. If the read count of the second received signal strength data is determined to be less than the read count of first received signal strength data, then the decision tree moves onto node 614. Node 616 may be a leaf node indicating that the tag is in the second tag volume (e.g. second room 2).

The third layer of the decision tree (and thus the third highest priority classification) may be based on one or more signal strength parameters relating to a peak signal strength received from the tag (e.g. respective parameters indicating the respective peak signal strengths in the first and second received signal strength data or a comparative parameter indicating the extent of the difference between the peak signal strengths in the first and second received signal strength data). The decision tree may be configured such that if, at node 608, a decision is made that the difference between the peak signal strength of the first received signal strength data and the peak signal strength of second received signal strength data is greater than a threshold, the decision tree moves to node 610, otherwise the decision tree moves to node 612. Node 610 may be a leaf node indicating that the tag is in the first tag volume (such as the first room 1). Node 612 may be a leaf node indicating that the tag is in the second tag volume (such as the second room 2).

The decision tree may be further configured such that if, at node 614, a decision is made that the difference between the peak signal strength of the first received signal strength data and the peak signal strength of second received signal strength data is greater than a threshold, the decision tree moves to node 618, otherwise the decision tree moves to node 620. Node 618 may be a leaf node indicating that the tag is in the second tag volume (e.g. the second room 2). Node 620 may be a leaf node indicating that the tag is in the first tag volume (e.g. the first room 1).

It will be understood that the decision tree arrangement in FIG. 6a is merely for illustration. The arrangement and number of nodes and the parameters on which decisions are based may be different from that shown. In particular, in some examples, a boosted decision tree may comprise more decision nodes and levels than the decision tree illustrated in FIG. 6a. Additionally or alternatively, although FIG. 6a is described with reference to direct comparisons between parameter values based on the first received signal strength data and parameter values based on the second received signal strength data, it will be understood that the decision nodes may alternatively comprise indirect comparisons, such as comparisons of the respective parameter values with respective predetermined threshold values.

For example, FIGS. 6b-6d together show an example trained gradient boosted decision tree. At each decision node of the tree, the point of peak data or a value of a further received signal parameter relating to a feature of the first received signal strength data or a value of a further received signal parameter relating to a feature of the second received signal strength data is compared to a threshold. The configuration of the tree, the parameters employed at each decision node and the thresholds are determined by training of the model. In this example, the root node 650 is based on the point of peak data. In this case, the point of peak data is provided by normalised time data relating to a normalised time at which the signal having the peak received signal strength of the first and second received signal strength data was received. The normalised time scale is between 0 and 1. If the normalised time at which the signal having the peak received signal strength of the first and second received signal strength data was received is greater than 0.54684 on the normalised time scale, then the gradient boosted decision tree moves to the left hand side of the tree (shown in FIG. 6d). If the normalised time at which the signal having the peak received signal strength of the first and second received signal strength data was received is greater than 0.54684 on the normalised time scale, then the gradient boosted decision tree moves to the right hand side of the tree (part of which is shown in FIG. 6b and part of which is shown in FIG. 6c). The other parameters on which the gradient boosted decision tree of FIGS. 6b-d are based include:
Signal strength parameters relating to the peak received signal strengths in the first (peak_at_10) and second (peak_at_11) received signal strength data;
Read count parameters relating to the number of reads of the tag in the first (reads_at_10) and second (reads_at_11) received signal strength data; and
Mean received signal strength parameters relating to the mean received signal strengths in the first (mean_at_10) and second (mean_at_11) received signal strength data.

Values of the signal strength parameters and mean received signal strength parameters may be in dBm.

It is noted that in this example some parameters are used in a plurality of different levels of the gradient boosted decision tree, albeit they are compared to different thresholds at different levels. This includes the point of peak data which is used at a plurality of different levels in the tree.

The leaf nodes at the ends of the various branches indicate classification decisions of the decision tree. A positive value of a leaf node in this example may be indicative that the tag is more likely to be in the second tag volume, the value being indicative of a determined probability with which the tag is in the second tag volume (on a scale of 0 to 1, 1 being most probable, 0 being least probable). A negative value of a leaf node in this example may be indicative that the tag is more likely to be in the first tag volume, the value being indicative of a determined probability with which the tag is in the first tag volume (on a scale of 0 to −1, −1 being most probable, 0 being least probable).

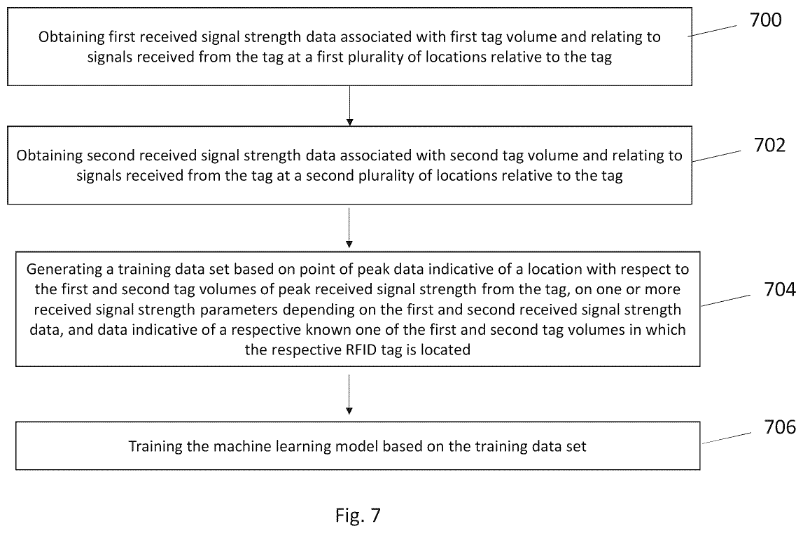

FIG. 7 shows an example method of training a machine learning model for determining a location of an RFID tag, such as by determining which of first and second tag volumes a detected RFID tag is located in. The method of FIG. 7 may be performed by the processing circuitry of the reader, by processing circuitry of one or more computing devices external to the reader (such as one or more servers 15) or partially by the reader and partially by processing circuitry of one or more external computing devices. The processing circuitry may be configured to implement the method of FIG. 7 by executing computer program instructions (i.e. in software), in hardware, in firmware or in any combination thereof. Memory may be provided for storing the computer program instructions, the processing circuitry being in communication with said memory in order to retrieve the computer program instructions therefrom. The trained machine learning model, for example if partially or fully trained in one or more computing devices external to the reader 10, may be communicated to and stored in memory of the reader for use in stock management and control operations. Alternatively the trained machine learning model may be stored on one or more computing devices external to the reader. In this case, received signal strength data read by the reader 10 from the tag, or one or more parameters derived therefrom, may be sent to the external computing device(s) for use with the trained model to identify the location of the tag. The external computing device(s) may return the classification decision to the reader for output to a user interface, or the classification decision may be output on another local computing device (for example).

The method of FIG. 7 may comprise generating one or more training data sets for training the machine learning model. One or more of the training data sets may be based on received signal strength training data associated with (e.g. captured in respective tag volumes of) one or more pairs of tag volumes different from the said first and second tag volumes in respect of which the trained model is to be used (e.g. one or more of the training data sets may be based on received signal strength training data associated with an arrangement of adjacent third and fourth tag volumes different from the arrangement of adjacent first and second tag volumes in respect of which the training model is to be used). For example, with reference to the example of FIG. 1, one or more of the training data sets may be based on received signal strength training data associated with a pair of (e.g. adjacent) rooms different from the first and second rooms 1, 2 of FIG. 1, such as first and second rooms of a store layout different from the store layout of FIG. 1. By training the machine learning model depending on one or more training data sets based on different pairs of tag volumes from those in respect of which the trained model is to be used, a trained machine learning model may be created which can be used without significant modification in respect of a number of different pairs of tag volumes (e.g. pairs of rooms of a number of different store layouts), such as in a number of different retail locations, thus making the model more widely applicable.

It will be understood that, additionally or alternatively, one or more (or each) of the training data sets may be based on received signal strength training data associated with (e.g. captured in respective tag volumes of) the said first and second tag volumes in respect of which the trained machine learning model is to be used (such as the first and second rooms 1, 2 in the example of FIG. 1). In some examples, it may be that the machine learning model is trained (e.g. exclusively) based on training data specific to the first and second tag volumes in respect of which it is to be used.

The method of FIG. 7 will be described with reference to a single training data set for simplicity, but it will be understood that a plurality of training data sets is typically generated and that the machine learning model is typically trained based on the plurality of training data sets. In addition, the method of FIG. 7 will be described with reference to a single RFID tag, but it will be understood that the method is typically performed in respect of each of a plurality of RFID tags. Generally, the training data should be based on received signal strength training data from tags at different locations distributed throughout the first and second training tag volumes and tag reads should be performed at a number of different distributed locations relative to the tag.

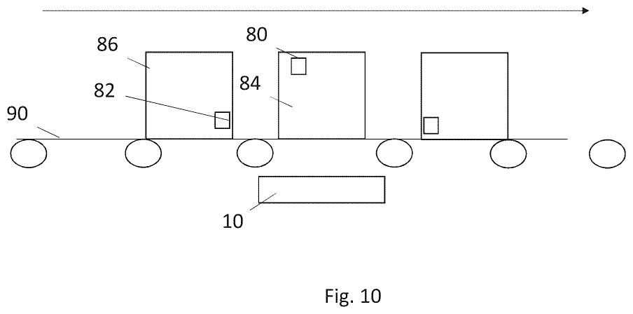

At 700 and 702, first and second received signal strength training data may be obtained, the first received signal strength training data being associated with a first training tag volume and being based on attempted detections of an RFID tag at a first plurality of locations relative to the tag and the second received signal strength training data associated with a second training tag volume and being based on attempted detections of the RFID tag at a second plurality of locations (typically different from the first plurality of locations) relative to the tag. The first and second training tag volumes may be adjacent to each other (e.g. separated by a dividing wall or floor/ceiling, such as a dividing wall or floor/ceiling through which RF signals can propagate). The first and second received signal strength training data may be acquired by the RFID tag reader in a similar or the same way as the first and second received signal strength data discussed above, for example sequentially at the first and second pluralities of locations. The first received signal strength training data may comprise (e.g. time stamped) received signal strengths of RF signals received by an RFID reader from the tag at each of a plurality of locations (e.g. distributed) within the first training tag volume (or outside of the first and second tag volumes but closer to the first tag volume than to the second tag volume—see below with reference to FIG. 10). The second received signal strength training data may comprise (e.g. time stamped) received signal strengths of RF signals received by an RFID reader from the tag at each of a plurality of locations (e.g. distributed) within the second training tag volume (or outside of the first and second tag volumes but closer to the second tag volume than to the first tag volume). The RFID tag may be located in one of the first and second training tag volumes, such as the first training tag volume. As set out above, it may be that the first and second training tag volumes are the same or different tag volumes in respect of which the trained machine learning model is to be used to determine the location of a detected tag.

At 704, a training data set may be generated based on the first and second received signal strength training data. The training data set may comprise point of peak data indicative of a location with respect to the first and second tag training volumes of peak (or maximum) received signal strength from the tag, determined depending on the first and second received signal strength training data. The point of peak data may be determined in any of the ways described herein with respect to the first and second received signal strength data. The training data set may also be based on (e.g. the training data set may comprise) value(s) of one or more further received signal parameters depending on the first and second received signal strength data. The one or more further received signal parameters may comprise for example, any one or more of the further received signal parameters discussed herein with respect to the first and second received signal strength data.

For example, as discussed above, the one or more further received signal parameters may comprise any two or more of: one or more further received signal parameters selectively based on the first received signal strength training data; one or more further received signal parameters selectively based on the second received signal strength training data; one or more further received signal parameters based on the combination of the first and second received signal strength training data. Additionally or alternatively, the one or more further received signal parameters may comprise one or more comparative received signal parameters, each of the one or more comparative received signal parameters being based on a respective comparison of the first and second received signal strength training data.

The training data set may be based on (e.g. the training data set may comprise) a plurality of further received signal parameters. The plurality of further received signal parameters may relate to a plurality of different features of the first received signal strength training data and a corresponding plurality of features of the second received signal strength training data. The plurality of received signal parameters may enable features specifically of the first received signal strength training data and (e.g. corresponding) features specifically of the second received signal strength training data to be taken into account.

The plurality of further received signal parameters may comprise any one or more or two or more of: one or more read count parameters relating to a number of reads of the tag; one or more read count parameters relating to a number of reads of the tag per unit time; one or more average (e.g. mean or median) received signal strength parameters relating to an average received signal strength of signals received from the tag; one or more parameters relating to a variation of received signal strengths of signals received from the tag; one or more parameters relating to a time or location at which a peak received signal strength was received from the tag; one or more signal strength parameters relating to a peak signal strength of signals received from the tag.

The training data set may further comprise data indicative of a known one of the first and second tag training volumes in which the respective RFID tag is located. The tag volume in which the respective RFID tag is located may be specified by an operator of the reader when the first and second received signal strength training data is acquired.

At 706, the machine learning model may be trained based on the training data set. The way in which the machine learning model is trained depends on the type of the machine learning model. For example, a gradient boosted decision tree can be generated based on one or more training data sets by the following method. An initial decision tree may be generated by selecting decision nodes of the tree based on the training data set(s) such that a loss function is minimised which relates the input data to the known one of the first and second tag volumes in which the respective RFID tag is located. The process of minimising the loss function may include iterative refinement of the decision tree (e.g. iterative refinement of the decision points of the tree). The size of the initial decision tree may be constrained, for example in terms of the number of levels it may have. Accordingly, the initial decision tree may be a “weak learner”. An iterative process may then be performed to generate additional decision trees which focus on minimising the residual from the previous trees. The combination of the determined decision trees forms the gradient boosted decision tree.

For example, it may be said that the initial tree is a function f₁(x) of the input parameters x from the training data set. The function f₁(x) should be arranged such that the known location y of the tag on which the training data is based can be determined from the initial decision tree based on the training data set. However, the initial tree may be imperfect, and the output of the function will not match the location y of the tag on which input data is based in all cases. Accordingly, it may be said that f₁(x)≈y. The residual of the initial decision tree is thus y−f₁(x). A second decision tree may be generated in order to create a function f₂(x) which minimises a loss function based on the residual from the initial tree. Again, the second decision tree is imperfect and the output of the function will not completely remove the residual from the initial tree. The second decision tree may be said to provide the function f₂(x)≈y−(x). The residual of the second decision tree is y−f₁(x)−f₂(x). A third decision tree may be generated in order to create a function f₃(x) which minimises a loss function based on the residual from the second decision tree. The third decision tree may be said to provide the function f₃(x)≈y−f₁(x)−f₂(x). The combination of the initial, second and third decision trees forms the gradient boosted decision tree.

It may be that a hyperparameter is used in the determination of the gradient boosted decision tree; alternatively it may be that no hyperparameter (or a hyperparameter of 1) is employed.

In other examples, alternative supervised classification algorithms can be trained based on the one or more training data sets, such as a Support Vector Machine, Naïve Bayes or Logistic Regression classifier.

As mentioned above, the machine learning model is typically trained based on a plurality of such training data sets relating to one or more environments, such as one or more (e.g. a plurality of different) store layouts, each comprising adjacent first and second tag volumes. In order to generate each of the training data sets, respective first and second received signal strength training data relating to one or more tags may be obtained as described above. In each case, the respective first and second received signal strength training data may comprise received (e.g. time stamped) signal strengths associated with the respective first and second tag training volumes and relating to signals received from the tag at respective first and second pluralities of locations relative to the tag. Each of the training data sets may be generated by determining, depending on the first and second received signal strength training data, point of peak data indicative of a location with respect to the respective first and second tag training volumes of peak (or maximum) received signal strength from the tag and values of one or more received signal parameters depending on the first and second received signal strength training data. The one or more further received signal parameters may comprise any one or more of the further received signal parameters discussed herein. For example, the one or more further received signal parameters may comprise a plurality of received signal parameters. The plurality of received signal parameters may relate to a plurality of different features of the first received signal strength training data and a corresponding plurality of features of the second received signal strength training data as discussed.

It may be that a K-fold shuffle split such as a 5-fold shuffle split is used for training and testing the machine learning model, such as the gradient boosted decision tree, based on the training data set(s). A 5-fold split means that four parts of the data are used as training data for training the machine learning model and one part is used as test data for testing the accuracy and generality of the trained model. Alternatively, a K-fold cross validation, such as a 5-fold cross validation, may be used for training and testing the machine learning model.

In this case, instead of statically using four of the five parts of the data for training and one of the five parts of the data for testing, five trained models are obtained, each using a different one of the five parts of the data as the testing data and the other four parts of the data as the training data. The trained models resulting from each round may be combined (e.g. averaged) to provide the final trained model. This helps to ensure that the trained machine learning model is not overtrained based on training data relating to any one environment or store layout. The training data sets may be shuffled, for example prior to training the machine learning model based on the training data. The training data sets may be shuffled, for example prior to splitting the data sets into training data and test data. Shuffling the data prior to training helps to better train the model as there is less possibility for the training process to become stuck in local minima.

Although the above description focusses on the determination of which of the first and second tag volumes a single RFID tag is located in, it will be understood that the methods described herein may be employed in the determination of which of the first and second tag volumes each of a plurality of RFID tags is located in, for example to assist with stock control and management. It will be understood that first and second received signal strength data may be determined for each tag and used as discussed above in order to determine which tag volume the tag is located in. It may be that the tag locations determined for the respective tags are recorded in a memory, such as in a database. It may be that the tag locations determined from the received first and second received signal strength data for the respective tags are compared with previously determined locations of the said tags. It may be that a stock control or management action is taken in response to the result of the said comparison, such as relocating an item associated with the tag to the other of the tag volumes (e.g. to replenish stock in a retail space or to relocate excess stock therefrom to a store room). It may be that an output of the tag volume in which the tag is determined to be located may be provided to the user or operator, for example by way of a user interface, such as an indication of the probability (which may be obtained from the trained machine learning model) with which the tag has been determined to be located in that particular tag volume. This may be useful information in locating the respective stock item corresponding to the tag.

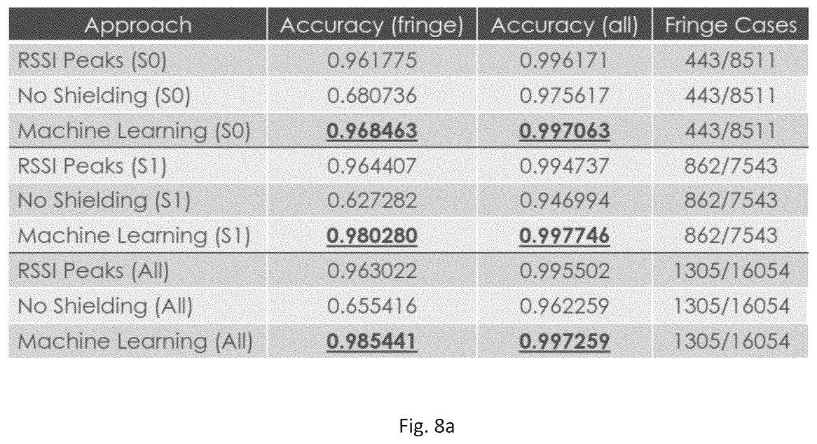

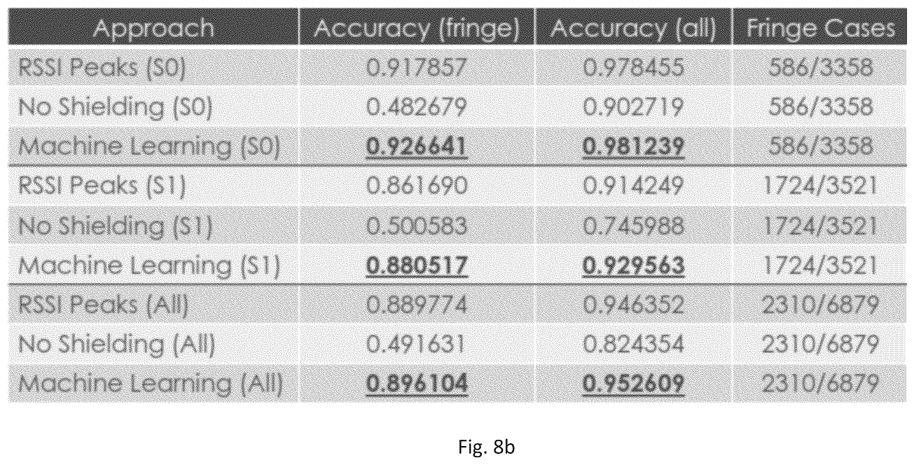

FIG. 8a shows the results from a field trial in which three different approaches were used to determine which of first and second tag volumes (in this case first and second rooms separated by a wall) a plurality of passive RFID tags were located in. The field trial was performed at a store in a shopping mall. The store layout comprised adjacent first and second rooms each comprising a plurality of passive RFID tags, the rooms being separated by an unshielded wall allowing the passage of RF signals therethrough. The three different approaches used in each of the trials to determine which of first and second tag volumes the RFID tags were located in are labelled in FIG. 8a: RSSI peaks; No shielding; and Machine Learning.

The results labelled “RSSI peaks” were obtained by performing RFID tag read operations in each of the first and second rooms, measuring and comparing the received signal strengths of RF signals received from the RFID tags in the first and second rooms, and inferring that the respective tags were located in the room in which the RF signal of greatest received signal strength was received from that tag. The results labelled “No shielding” were based on assigning the tags to their last known location.

The results labelled “Machine Learning” were obtained by inputting determined input data to a trained gradient boosted decision tree, the decision tree outputting an indication of which of the two rooms it was most likely that the respective tags were located in based on the input data. The gradient boosted decision tree was trained based on training data sets acquired in the store layout where the trial was performed.

The training data sets were each derived from respective first and second received signal strength training data comprising time stamped received signal strengths associated with the respective first and second rooms of the store and relating to signals received from tags at respective first and second pluralities of locations relative to the tags within the respective first and second rooms, and time stamps associated with when the signals associated with the received signal strengths were received. Each of the training data sets comprised: point of peak data indicative of a location with respect to the first and second tag volumes of peak (or maximum) received signal strength from the tag; respective read count parameters relating to the number of reads of the tag in the first received signal strength training data, the number of reads of the tag in the corresponding second received signal strength training data and the total number of reads of the tag in the combination of the corresponding first and second received signal strength training data; the normalised times of the peak signal strengths in the first received signal strength training data, the corresponding second received signal strength training data and the combination of the corresponding first and second received signal strength training data; the mean received signal strength of the first received signal strength training data, the mean received signal strength of the corresponding second received signal strength training data, the mean received signal strength of the combination of the corresponding first and second received signal strength training data; the peak received signal strengths of the corresponding first and second received signal strength training data; and all of the time stamped received signal strengths of the first and second received signal strength training data. A 5-fold shuffle split was used for training and testing the model with a 5-fold cross validation.

In order to use the gradient boosted decision tree, input data was determined and input to the gradient boosted decision tree for each of the tags. It was then determined from the gradient boosted decision tree based on the input data which of the rooms the respective tags were located. For each of the tags, the input data was determined from first and second received signal strength data comprising received signal strengths associated with the respective first and second rooms and relating to signals received from the tag at respective first and second pluralities of locations relative to the tag within the respective first and second rooms, and time stamps associated with when the signals associated with the received signal strengths were received. The determined parameters input to the decision tree included: point of peak data indicative of a location with respect to the first and second tag training volumes of peak (or maximum) received signal strength from the tag, determined depending on the first and second received signal strength data; respective read count parameters relating to the number of reads of the tag in the first received signal strength data, the number of reads of the tag in the corresponding second received signal strength data and the total number of reads of the tag in the combination of the corresponding first and second received signal strength data; the normalised times of the peak signal strengths in the first received signal strength data, the corresponding second received signal strength data and the combination of the corresponding first and second signal strength data; the mean received signal strength of the first received signal strength data, the mean received signal strength of the corresponding second received signal strength data, the mean received signal strength of the combination of the corresponding first and second received signal strength data; the peak received signal strengths of the corresponding first and second received signal strength data; and all of the time stamped received signal strengths of the first and second received signal strength data.

The results of FIG. 8a show the accuracies of the determinations of the tag volumes in which the tags were located for each approach, for the tags of the first tag volume, the tags of the second tag volume and all of the results combined, as a fraction of 1 (i.e. 1 being 100% accurate, 0.943959 being 94.3959% accurate and so on). The results labelled (S0) refer to a first scanning session of the tags where each tag is read multiple times without cool-down, in response to trigger signals transmitted by the reader continuously or substantially continuously. The results labelled (S1) refer to a second session where a time gap is provided between tag reads (e.g. by the reader leaving time gaps between successive trigger signals), such that the results in the second session S1 are based on fewer tag reads than the results in the first session S0. The results labelled (All) relate to the combination of the results of (S0) and (S1).

The column “Accuracy (fringe)” refers to the accuracy of the determination of which of the first and second rooms the tags are located in selectively for tags which were read in both the first and second rooms (and which were therefore in greater danger of being misplaced). The column “Accuracy (all)” refers to the accuracy of the determination of which of the first and second rooms the tags are located in for all detected tags, including both tags which were read in both the first and second rooms and tags which were read in a single one of the first and second rooms. The column “Fringe cases” refers to the number of tags which were detected in both the first and second rooms as a proportion of the total number of detected tags.

It can be seen from the results of FIG. 8a that both the RSSI peaks approach and the Machine Learning approach are more accurate than the No Shielding approach. In addition, it can be seen that the Machine Learning approach provides improved accuracy compared to the RSSI approach, particularly for “fringe cases”, the improvement in accuracy being more marked in session S1 when fewer tag reads are available.

FIG. 8b shows results of a similar trial in a different store layout. It can be seen from the results of FIG. 8b that again both the RSSI peaks approach and the Machine Learning approach are more accurate than the No Shielding approach. In addition, it can be seen again that the Machine Learning approach provides improved accuracy compared to the RSSI approach, particularly for “fringe cases”, the improvement in accuracy being more marked in session S1 when fewer tag reads are available.

The improved accuracy of the Machine Learning approach over the “RSSI peaks” approach may be attributed to the parameters used by the Machine Learning approach in addition to the data indicative of the room in which the peak received signal strength was observed as used in the “RSSI peaks” approach. It is expected that further improved results would be obtained by the Machine Learning approach with more training of the model.

It will be appreciated that, as discussed above, accurate results may also be achieved by an alternative approach which does not use Machine Learning but which takes into account values of one or more parameters determined from first and second received signal strength data in addition to the point of peak data. In an example, in order to take into account the point of peak data and the one or more further received signal parameters at 408 to determine which of the tag volumes the tag is located in, processing circuitry of the reader (such as the reader 10) or one or more computing devices (such as server 15) external to the reader may execute a computer program implementing an if/then or if/then/else structure (such as a nested if/then/else or if/then structure or a nested structure comprising a combination of if/then/else and if/then structures) based on the input data and the predetermined reference data. As a simple example, the following pseudo code may be implemented:
if point of peak data is indicative that location of peak received signal strength from the tag is associated with the first tag volume,
then
   if read count of first received signal strength data is greater than or equal to read count of second received signal strength data
   then output determination that tag is located in first tag volume
   else
      if difference between peak signal strength of first received signal strength data and peak signal strength of second received signal strength is greater than a predetermined threshold
      then output determination that tag is located in first tag volume
      else
else
   output determination that tag is located in second tag volume.

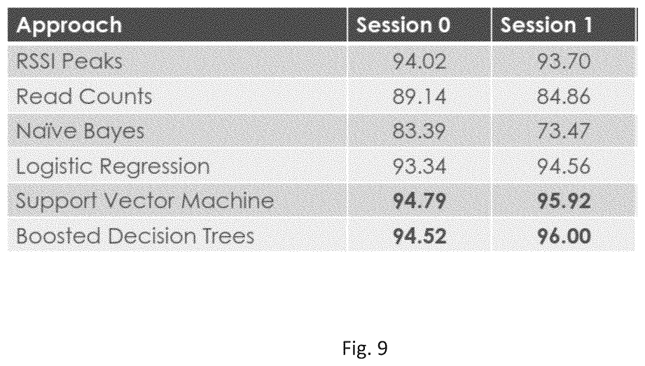

It should be noted however that, although other approaches are possible, the rigour of the Machine Learning approach helps to optimise the accuracy of the results. In particular, the gradient boosted decision tree has been found to be particularly well adapted for use in determining which of first and second rooms a detected RFID tag may be located in based on the parameters determined from the first and second received signal strength data discussed herein. Support vector machine models are also particularly well adapted. This is illustrated in FIG. 9 which shows the results of an experimental study in which several different approaches were used to determine which of first and second adjacent rooms an RFID tag was located in based on time stamped signal strengths detected from the tag at respective pluralities of locations relative to the tag in the first and second rooms. The approaches were: RSSI peaks; Read counts; Naïve Bayes; Logistic Regression; Support Vector Machine; and Boosted Decision trees. The RSSI peaks approach is explained above. The Read counts approach is to determine the room in which the tag is located by determining the number of read counts of the tag in each of the rooms and determining that the tag is located in the room in which the highest read count was obtained. The Naïve Bayes, Logistic Regression, Support Vector Machine and Boosted Decision Tree approaches are all different machine learning approaches trained on the same training data.

As before, the results in the columns labelled session 0 and session 1 are percentage accuracies of determinations of the rooms in which the respective tags were located. Session 0 refers to a first scanning session of the tags where each tag is read multiple times without cool-down, in response to trigger signals transmitted by the reader continuously or substantially continuously. Session 1 refers to a second session where a time gap is provided between tag reads (e.g. by the reader leaving time gaps between successive trigger signals), such that the results in session 1 are based on fewer tag reads than the results in session 0.

It can be seen from FIG. 9 that the Support Vector Machine and Boosted Decision Tree approaches both yield improvements over the RSSI peaks approach. That said, it is expected that each of machine learning approaches would yield improved results with further training.

In the example of FIG. 1, the first received signal strength data associated with the first tag volume (the first room 1 in this case) relates to signals received from the tag at a first plurality of locations relative to the tag, the first plurality of locations being within the first tag volume (the first room 1). Similarly, the second received signal strength data associated with the second tag volume (the second room 2 in this case) relates to signals received from the tag at a second plurality of locations relative to the tag, the second plurality of locations being within the second tag volume (the second room 2). The reader (such as the reader 10) is moved sequentially through the first plurality of locations within the first tag volume and sequentially through the second plurality of locations within the second tag volume to acquire the first and second received signal strength data. The tags may remain in a fixed location during the reading operations.

In another example, rather than the RFID tag reader moving relative to the RFID tags, it may be that the RFID tags move relative to the RFID tag reader. For example, as illustrated in FIG. 10, RFID tags 80, 82 may be provided in each of first and second tag volumes 84, 86 respectively. The first and second tag volumes 84, 86 may be containers such as boxes containing the tags 80, 82. As before, it may be that the respective RFID tags 80, 82 are attached to or integrated within respective products or their packaging. The first and second tag volumes 84, 86 may be moveable relative to the reader 10, for example by way of a conveyor belt 90 on which the first and second tag volumes are provided. The reader 10 may be provided (e.g. mounted) in a fixed position. The reader 10 may be provided outside of the first and second tag volumes 84, 86.

Although the first and second tag volumes 84, 86 are separated by an air gap in the example of FIG. 10, the first and second tag volumes 84, 86 may instead abut each other. In either case, there may be a relatively small gap (if any) between the first and second tag volumes 84, 86. It may be that the walls of the first and second tag volumes 84, 86 (in particular the side wall of the tag volume 84 closest to tag volume 86 and the side wall of the tag volume 86 closest to tag volume 84) are unshielded. Thus, as above, it may be that RFID signals can pass through the walls of the first and second tag volumes 84, 86 relatively unattenuated. As above, it can be desirable to determine which of the first and second tag volumes 84, 86 the tags 80, 82 are located in, for example for stock control and management.

As the first and second tag volumes 84, 86 are conveyed on the conveyor belt (e.g. in the left to right direction as shown in FIG. 10) in the vicinity of the reader 10, the reader 10 may perform a plurality of tag reading operations. For example, the RFID tags 80, 82 may be passive RFID tags and the reader 10 may emit RF trigger signals, power from which is used by the RFID tags 80, 82 to transmit response signals to the reader 10. In the example of FIG. 10, the first tag volume 84 leads the second tag volume 86 when the conveyor belt 90 is conveying the first and second tag volumes 84, 86 in the left to right direction. Different ones of the tag volumes 84, 86 may be closer to the reader 10 at any given time. A first plurality of RFID tag reading operations may performed by the reader 10 when the first tag volume 84 is closer to the reader 10 than the second tag volume 86, such as when the first tag volume 84 approaches and passes the reader 10. A second plurality of RFID tag reading operations may be performed by the reader 10 when the second tag volume 86 is closer to the reader 10 than the first tag volume 84, such as when the first tag volume 84 has passed the reader 10 and the second tag volume 86 approaches and passes the reader 10. During the first and second RFID tag read operations the reader 10 may measure the received signal strength of signals received from the RFID tags 80, 82, extract the unique identifiers of the tags 80, 82 from the signals received from the RFID tags 80, 82 and time stamp the signals received from the respective tags. The received signal strength data, unique identifiers and time stamps of the first RFID tag read operations may provide first received signal strength data and the received signal strength data, unique identifiers and time stamps of the second RFID tag read operations may provide second received signal strength data. As before, the first received signal strength data is associated with a first tag volume (tag volume 84) and relates to signals received from the tags at a first plurality of locations relative to the tags, and the second received signal strength data is associated with a second tag volume (tag volume 86) different from the first tag volume and relates to signals received from the tags at a second plurality of locations relative to the tags.

As before, although whether the first or the second received signal strength data comprises signal strength data relating to the peak received signal strength from a respective tag is an indicator of which of the first and second tag volumes that tag is located in, determining which of the first and second tag volumes the tag is located in based only on that indicator is prone to error. This is particularly true in fringe cases where the tags are located near the side walls of the tag volumes closest to the other tag volume, and for example when the first and second tag volumes 84, 86 are close together.

As discussed above, including with respect to the methods of FIGS. 4, 5 and 7, the first and second received signal strength data can be processed to determine which of the tag volumes 84, 86 a detected tag 80, 82 is located in. For example, point of peak data indicative of a location with respect to the first and second tag volumes 84, 86 of peak received signal strength from the tag may be determined depending on the first and second received signal strength data. For example, the point of peak data may be indicative that the location with respect to the first and second tag volumes 84, 86 of peak received signal strength from the tag is when the first tag volume is closer to the reader than the second tag volume is to the reader (which may make it more likely that the tag is in the first tag volume) or vice versa. In addition, values of one or more further received signal parameters can be determined depending on the first and second received signal strength data. It can then be determined which of the first and second tag volumes the RFID tag is more likely to be located in depending on the point of peak data and on the one or more further received signal parameters. The received signal parameters may be any one or more, or any combination, of the received signal parameters discussed herein.

It will be understood that the above-described techniques, including the machine learning techniques and the received signal parameters discussed above, are also equally applicable to the situation of FIG. 10 for determining which containers RFID tags are located in. The disclosure therefore extends to determining the tag volume 84, 86 in which one or more RFID tags are located by comparing input data to predetermined reference data such as a trained machine learning model (such as a decision tree, such as a gradient-boosted decision tree), the input data being based on the point of peak data and on the one or more further received signal parameters relating to that tag. The one or more further received signal parameters may comprise any one or more of the further received signal parameters described herein. For example, the one or more further received signal parameters may comprise a plurality of received signal parameters. The plurality of received signal parameters may relate to a plurality of different features of the first received signal strength data and a corresponding plurality of features of the second received signal strength data.

As above, the machine learning model may be trained based on one or more training data sets relating to first and second signal strength training data acquired using the same or a similar set up to that of FIG. 10, each of the training data sets being based on known locations (e.g. tag volumes, e.g. containers) of RFID tags and first and second received signal strength training data relating to signals received by a (e.g. static) reader from RFID tags passing the reader in different tag volumes (e.g. tag volumes, e.g. containers). Each of the training data sets may be based on point of peak data indicative of a location with respect to the first and second tag volumes 84, 86 of peak received signal strength from the tag, determined depending on the first and second received signal strength training data, and on value(s) of one or more further received signal parameters based on the first and second received signal strength training data. The one or more further received signal parameters may comprise any one or more, or any combination, of the further received signal parameters described herein. For example, as above, the one or more further received signal parameters may comprise a plurality of (e.g. different) received signal parameters. The plurality of received signal parameters may relate to a plurality of different features of the first received signal strength training data and a corresponding plurality of features of the second received signal strength training data.

As discussed above, the processing may be performed by processing circuitry 12 of the reader 10, or by processing circuitry of one or more computing devices 15 external to the reader 10 (such as one or more server computers and/or one or more local computing devices, which may be in communication with the reader 10 so as to receive therefrom the first and second signal strength data or data from which it can be derived) or partially by the processing circuitry 12 of the reader 10 and partially by one or more computing devices external to the reader 10.

It may be that the tag locations determined from the received first and second received signal strength data for the respective tags are recorded in a memory, such as in a database. An output may be provided to an operator or user, such as by way of a user interface, indicating which tag volume the tag is determined to be located in, such as by way of a probability (e.g. from the machine learning model) with which it was determined that the tag is located in that tag volume. It may be that the tag locations determined from the received first and second received signal strength data for the respective tags are compared with previously determined locations of the said tags. It may be that a stock control or management action is taken in response to the result of the said comparison, such as relocating a stock item from a store room to a shop floor to replenish stock on the shop floor, or to relocate excess stock from the shop floor to the store room.

Although the above description refers to first and second tag volumes being different first and second tag volumes, it will be understood that the first and second tag volumes may be similar or identical to each other (or indeed different from each other in that they may be of different shape, construction or different shape and construction), but different in the sense that they are distinct from each other.

The disclosure also extends to the following examples.

### Examples

1. A (e.g. computer-implemented) method of determining a location of an RFID tag, the method comprising:
obtaining first received signal strength data associated with a first tag volume and relating to signals received from the tag at a first plurality of locations relative to the tag, and second received signal strength data associated with a second tag volume different from the first tag volume and relating to signals received from the tag at a second plurality of locations relative to the tag;
determining, depending on the first and second received signal strength data, point of peak data indicative of a location with respect to the first and second tag volumes of peak (or maximum) received signal strength from the tag;
determining value(s) of one or more further received signal parameters depending on the first and second received signal strength data; and
determining which of the first and second tag volumes the RFID tag is more likely to be located in depending on the point of peak data and on the determined values of the one or more further received signal parameters.

2. The method of example 1 further comprising outputting an indication of which of the first and second tag volumes the RFID tag is more likely to be located in, for example based on the said determination of which of the first and second tag volumes the RFID tag is more likely to be located in.

3. The method of example 1 or example 2 wherein the one or more further received signal parameters comprise a plurality of received signal parameters.

4. The method of any one of examples 1 to 3 wherein the one or more further received signal parameters comprise any two or more of: one or more further received signal parameters selectively based on the first received signal strength data; one or more further received signal parameters selectively based on the second received signal strength data; one or more further received signal parameters based on the combination of the first and second received signal strength data.

5. The method of any one of examples 1 to 4 wherein the one or more further received signal parameters comprise one or more comparative received signal parameters, each of the one or more comparative received signal parameters being based on a respective comparison of (e.g. corresponding features of) the first and second received signal strength data.

6. The method of any one of examples 1 to 5 wherein the one or more further received signal parameters comprise any one or more of: one or more received signal parameters selectively based on the first received signal strength data and one or more corresponding received signal parameters selectively based on the second received signal strength data; one or more received signal parameters selectively based on the first received signal strength data and one or more corresponding received signal parameters based on the combination of the first and second received signal strength data; one or more received signal parameters selectively based on the first received signal strength data, one or more received signal parameters selectively based on the second received signal strength data and one or more corresponding received signal parameters based on the combination of the first and second received signal strength data.

7. The method of any one of examples 1 to 6 wherein the one or more further received signal parameters comprise any one or more of: a plurality of (e.g. different) received signal parameters selectively based on the first received signal strength data and a corresponding plurality of received signal parameters selectively based on the second received signal strength data; a plurality of (e.g. different) received signal parameters selectively based on the first received signal strength data and a corresponding plurality of received signal parameters based on the combination of the first and second received signal strength data; a plurality of (e.g. different) received signal parameters selectively based on the first received signal strength data, a corresponding plurality of received signal parameters selectively based on the second received signal strength data and a corresponding plurality of received signal parameters based on the combination of the first and second received signal strength data.

8. The method of any one of examples 1 to 7 wherein the first received signal strength data associated with the first tag volume relates to received signal strength measurements made within the first tag volume and the second received signal strength data associated with second tag volume relates to received signal strength measurements made within second tag volume.

9. The method of any one of examples 1 to 8 wherein the first and second tag volumes comprise or consist of (e.g. adjacent) first and second rooms, such as first and second rooms each comprising one or more RFID tags.

10. The method of any one of examples 1 to 7 wherein the first received signal strength data associated with the first tag volume relates to measurements made outside of the first and second tag volumes but closer to the first tag volume than to the second tag volume and the second received signal strength data associated with second tag volume relates to measurements made outside of the first and second tag volumes but closer to the second tag volume than to the first tag volume.

11. The method of example 10 wherein the first and second tag volumes comprise or consist of first and second containers (e.g. boxes), such as first and second containers each comprising one or more RFID tags.

12. The method of any one of examples 1 to 11 wherein the one or more further received signal parameters comprise one or more read count parameters relating to a number of reads of the tag.

13. The method of any one of examples 1 to 12 wherein the one or more further received signal parameters comprise one or more read count parameters relating to a number of reads of the tag per unit time.

14. The method of any one of examples 1 to 13 wherein the one or more further received signal parameters comprise one or more average received signal strength parameters relating to an average (e.g. mean or median) received signal strength of signals received from the tag.

15. The method of any one of examples 1 to 14 wherein the one or more further received signal parameters comprise one or more parameters relating to a variation of received signal strengths of signals received from the tag.

16. The method of any one of examples 1 to 15 wherein the one or more further received signal parameters comprise one or more parameters relating to a time or location at which a peak received signal strength was received from the tag.

17. The method of any one of examples 1 to 16 wherein the one or more further received signal parameters comprise one or more signal strength parameters relating to a peak signal strength of signals received from the tag.

18. The method of any one of examples 1 to 17 wherein the one or more further received signal parameters comprises a peak signal strength difference parameter relating to a difference between peak signal strengths of the first and second received signal strength data.

19. The method of any one of examples 1 to 18 wherein the first and second received signal strength data each comprise time stamp data relating to times at which the respective signals were received from the tag and wherein value(s) of one or more of the further received signal parameters depend on the respective time stamp data.

20. The method of any one of examples 1 to 19 wherein the first and second received signal strength data is based on time stamped received signal strength data relating to signals received from the tag at the said first and second pluralities of locations relative to the tag, and wherein the point of peak data comprises data relating to a time at which a signal having the peak received signal strength of the first and second received signal strength data was received.

21. The method of any one of examples 1 to 20 wherein determining which of the first and second tag volumes the RFID tag is more likely to be located in comprises causing a comparison of (e.g. comparing) input data to predetermined reference data, the input data being based on the point of peak data and the determined value(s) of the one or more further received signal parameters.

22. The method of any one of examples 1 to 21 wherein determining which of the first and second tag volumes the RFID tag is more likely to be located in comprises:
causing input data to be input (e.g. inputting input data) to a trained machine learning model, the input data being based on the point of peak data and the determined values of the one or more further received signal parameters; and
obtaining from the trained machine learning model an indication of which of the first and second tag volumes the RFID tag is more likely to be located in.

23. The method of example 22 further comprising obtaining from the trained machine learning model a probability that the RFID tag is located in the said tag volume of the first and second tag volumes.

24. The method of example 22 or example 23 wherein the machine learning model is trained based on one or more training data sets, each of the one or more training data sets being based on a known one of first and second training tag volumes in which an RFID tag is located, point of peak data indicative of a location with respect to the first and second training tag volumes of peak received signal strength from the RFID tag and training value(s) of the one or more further received signal parameters.

25. The method of example 25 wherein the said point of peak data and training values of said parameter(s) are based on first and second received signal strength training data, the first received signal strength training data being associated with the first training tag volume and relating to signals received from the tag at a first plurality of locations relative to the tag and the second received signal strength training data associated with the second training tag volume (e.g. adjacent to the first training tag volume) and relating to signals received from the tag at a second plurality of locations relative to the tag. It may be that the respective first plurality of locations is within the respective first training tag volume and the respective second plurality of locations is within the respective second training tag volume. Alternatively, it may be that the respective first received signal strength training data relates to measurements made outside of the respective first and second training tag volumes but closer to the respective first training tag volume than to the respective second training tag volume and the respective second received signal strength training data relates to measurements made outside of the respective first and second training tag volumes but closer to the respective second training tag volume than to the respective first training tag volume.

26. The method of any one of examples 22 to 25 wherein the machine learning model is trained based on training data at least some of which is associated with tag volumes different from the first and second tag volumes.

27. The method of any one of examples 22 to 26 wherein the machine learning model is trained based on one or more training data sets based on received signal strength training data associated with (e.g. captured in respective tag volumes of) a pair of tag volumes different from the said first and second tag volumes.

28. The method of any one of examples 22 to 27 wherein the first and second tag volumes are (e.g. adjacent) first and second rooms and wherein the machine learning model is trained based on one or more training data sets based on received signal strength training data associated with (e.g. captured in respective tag volumes of) a pair of (e.g. adjacent) rooms different from the said first and second rooms.

29. The method of any one of examples 22 to 28 wherein the first and second tag volumes are (e.g. adjacent) first and second rooms of a first store layout and wherein the machine learning model is trained based on one or more training data sets based on received signal strength training data associated with (e.g. captured in respective) (e.g. adjacent) first and second rooms of a second store layout different from the first store layout.

30. The method of any one of examples 22 to 29 wherein the machine learning model is trained based on one or more training data sets based on received signal strength training data associated with (e.g. captured in) the said first and second tag volumes.

31. The method of any one of examples 22 to 30 wherein the machine learning model is trained based on at least first and second training data sets, the first training data set being based on received signal strength training data associated with (e.g. captured in respective tag volumes of) a first pair of tag volumes and the second training data set being based on received signal strength training data associated with (e.g. captured in respective tag volumes of) a second pair of tag volumes different from first pair of tag volumes.

32. The method of any one of examples 22 to 31 wherein the machine learning model comprises a decision tree, such as a gradient boosted decision tree, or a support vector machine.

33. The method of any one of examples 1 to 32 wherein the first and second tag volumes or the first and second training tag volumes are adjacent to each other.

34. The method of any one of examples 1 to 33 wherein the first and second tag volumes or the first and second training tag volumes are separated by one or more walls which allow radio frequency signals from the RFID tag to pass therethrough.

35. The method of any one of examples 1 to 34 wherein the RFID tag is coupled to a stock item.

36. The method of any one of examples 1 to 35 wherein the point of peak data is indicative that the location of peak received signal strength from the tag is associated with a first one of the first and second tag volumes, and wherein the method comprises determining that the RFID tag is located in a different one of the first and second tag volumes from the said first one depending on the determined values of the further received signal parameters.

37. The method of example 36 wherein the further received signal parameters relate to a plurality of (e.g. two or more or three or more) different features of the first received signal strength data and a corresponding plurality of (e.g. two or more or three or more) features of the second received signal strength data, such as a plurality of received signal parameters enabling features specifically of the first received signal strength data and (e.g. corresponding) features specifically of the second received signal strength data to be taken into account.

38. The method of example 37 wherein the features of the respective received signal strength data comprise any one or more of: a number of reads of the tag; a number of reads of the tag per unit time; an average (e.g. mean or median) received signal strength of signals received from the tag; a variation of received signal strengths of signals received from the tag; a time or location at which a peak received signal strength was received from the tag; a peak signal strength of signals received from the tag.

39. The method of any one of examples 1 to 35 wherein the point of peak data is indicative that the location of peak received signal strength from the tag is associated with a first one of the first and second tag volumes, and wherein the method comprises determining that the RFID tag is located in the tag volume associated with the peak received signal strength from the tag depending on the determined values of the one or more further received signal parameters.

40. The method of any one of examples 1 to 39 wherein the first received signal strength data relates to signals received from the tag at the first plurality of locations relative to the tag, successive signals of which have a time gap between them (e.g. to allow cool-down of the tag between the signals) and wherein the second received signal strength data relates to signals received from the tag at the second plurality of locations relative to the tag, successive signals of which have a time gap between them (e.g. to allow cool-down of the tag between the signals).

41. A computer-implemented method of training a machine learning model (such as a decision tree, such as a gradient boosted decision tree, or a support vector machine) for determining a location of an RFID tag, the method comprising:
obtaining first received signal strength data associated with a first tag volume and relating to signals received from one or more RFID tags at a first plurality of locations relative to the tag(s), and second received signal strength data associated with a second tag volume different from the first tag volume and relating to signals received from one or more RFID tags at a second plurality of locations relative to the tag(s);
generating a training data set by, for each of the one or more RFID tags, determining, depending on the first and second received signal strength data, point of peak data indicative of a location with respect to the first and second tag volumes of peak received signal strength from the tag, determining value(s) of one or more further received signal parameters (such as any one or more of the received signal parameters discussed herein) depending on the first and second received signal strength data, and identifying a respective known one of the first and second tag volumes in which the respective RFID tag is located; and
training the machine learning model based on the training data set.

42. The computer-implemented method according to example 41 wherein the first and second tag volumes are adjacent to each other.

43. The computer-implemented method of example 41 or example 42 wherein the first and second tag volumes are separated by one or more walls which allow radio frequency signals from the RFID tag to pass therethrough.

44. The computer-implemented method of any one of examples 41 to 43 wherein the training data set is based on, for each of the said one or more RFID tags, data indicative of the known one of the first and second tag volumes in which the respective RFID tag is located, the point of peak data and the values of the one or more further received signal parameters.

45. The computer-implemented method of any one of examples 41 to 44 comprising training the machine learning model based on at least first and second training data sets, the first training data set being based on first received signal strength training data associated with a first pair of tag volumes and a known tag volume of the first pair of tag volumes of an RFID tag to which the first received signal strength training data relates and the second training data set being based on second received signal strength training data associated with a second pair of tag volumes different from first pair of tag volumes and a known tag volume of the second pair of tag volumes of an RFID tag to which the second received signal strength training data relates.

46. The computer-implemented method of any one of examples 41 to 45 wherein the first and second received signal strength data comprises time stamp data relating to times at which the respective signals were received from the tag and wherein value(s) of one or more of the further received signal parameters depend on the said time stamp data.

47. The computer-implemented method of any one of examples 41 to 46 wherein training the machine learning model comprises, for each of one or more of the RFID tags:
inputting to the machine learning model input data based on values of the one or more further received signal parameters and the point of peak data;
determining based on the input data and the machine learning model which of the first and second tag volumes is more likely to contain the RFID tag and outputting an indication thereof;
comparing the said indication output by the machine learning model to the known one of the first and second tag volumes in which the tag is located; and
refining the machine learning model depending on the comparison between the said indication output by the machine learning model and the known one of the first and second tag volumes in which the tag is located.

48. The computer-implemented method of any one of examples 41 to 47 further comprising:
obtaining third received signal strength data associated with a third tag volume and relating to signals received from one or more RFID tags at a third plurality of locations relative to the tag(s), and fourth received signal strength data associated with a fourth tag volume different from the third tag volume and relating to signals received from one or more RFID tags at a fourth plurality of locations relative to the tag(s);
generating a further training data set by, for each of the one or more RFID tags, determining, depending on the third and fourth received signal strength data, point of peak data indicative of a location with respect to the third and fourth tag volumes of peak received signal strength from the tag, determining value(s) of one or more further received signal parameters depending on the third and fourth received signal strength data, and identifying a respective known one of the third and fourth tag volumes in which the respective RFID tag is located; and
training the machine learning model based on the further training data set.

49. The computer-implemented method according to example 48 wherein the third and fourth tag volumes are adjacent to each other, for example the third and fourth tag volumes may be separated from each other by a wall which allows RF signals to pass therethrough.

50. The computer-implemented method according to example 48 or example 49 wherein at least one of the third and fourth tag volumes is different from the first and second tag volumes.

51. A computer-implemented method of generating a training data set for training a machine learning model (such as a decision tree, such as a gradient boosted decision tree, or a support vector machine) for determining a location of an RFID tag, the method comprising:
obtaining first received signal strength data associated with a first tag volume and relating to signals received from one or more RFID tags at a first plurality of locations relative to the tag(s), and second received signal strength data associated with a second tag volume different from the first tag volume and relating to signals received from one or more RFID tags at a second plurality of locations relative to the tag(s); and
generating a training data set by, for each of the one or more RFID tags, determining, depending on the first and second received signal strength data, point of peak data indicative of a location with respect to the first and second tag volumes of peak received signal strength from the tag, determining value(s) of one or more further received signal parameters (such as any one or more of the received signal parameters discussed herein) depending on the first and second received signal strength data, and identifying a respective known one of the first and second tag volumes in which the respective RFID tag is located.

52. The computer-implemented method of any of examples 41 to 51 wherein the one or more received signal parameters comprises a plurality of received signal parameters relating to a plurality of different features of the first received signal strength data and a corresponding plurality of features of the second received signal strength data.

53. The computer-implemented method of any of examples 41 to 52 wherein the features of the respective received signal strength data may comprise any one or more of: a number of reads of the tag; a number of reads of the tag per unit time; an average (e.g. mean or median) received signal strength of signals received from the tag; a variation of received signal strengths of signals received from the tag; a time or location at which a peak received signal strength was received from the tag; a peak signal strength of signals received from the tag.

54. The computer-implemented method according to any one of examples 41 to 53 wherein the one or more further received signal parameters comprise any two or more of: one or more further received signal parameters selectively based on the first received signal strength data; one or more further received signal parameters selectively based on the second received signal strength data; one or more further received signal parameters based on the combination of the first and second received signal strength data.

55. The computer-implemented method according to any one of examples 41 to 54 wherein the one or more further received signal parameters comprise one or more comparative received signal parameters, each of the one or more comparative received signal parameters being based on a respective comparison of (e.g. corresponding features of) the first and second received signal strength data.

56. A machine learning model (such as a decision tree, such as a gradient boosted decision tree, or a support vector machine), such as a machine learning model for determining a location of an RFID tag, trained by the computer-implemented method of any one of examples 41 to 50 or based on one or more training data sets generated by the method of any one of examples 51 to 55.

57. A machine learning model (such as a decision tree, such as a gradient boosted decision tree, or a support vector machine), such as a machine learning model for determining a location of an RFID tag, trained based on one or more training data sets, each of the training data sets being based on a known one of first and second training tag volumes in which an RFID tag is located, point of peak data indicative of a location with respect to the first and second training tag volumes of peak received signal strength from the RFID tag and training value(s) of one or more further received signal parameters (such as any of the received signal parameters discussed herein).

58. The machine learning model according to example 57 wherein the said point of peak data and training values of said parameter(s) are based on first and second received signal strength training data, the first received signal strength training data being associated with the first training tag volume and relating to signals received from the tag at a first plurality of locations relative to the tag and the second received signal strength training data associated with the second training tag volume (e.g. adjacent to the first training tag volume) and relating to signals received from the tag at a second plurality of locations relative to the tag.

59. A machine learning model according to example 57 or example 58 wherein the one or more further received signal parameters comprise any one or more of: one or more read count parameters relating to a number of reads of the tag; one or more read count parameters relating to a number of reads of the tag per unit time; one or more average (e.g. mean or median) received signal strength parameters relating to an average received signal strength of signals received from the tag; one or more parameters relating to a variation of received signal strengths of signals received from the tag; one or more parameters relating to a time or location at which a peak received signal strength was received from the tag; one or more signal strength parameters relating to a peak signal strength of signals received from the tag.

60. A machine learning model according to any of examples 57 to 59 wherein the one or more further received signal parameters comprise any two or more of: one or more further received signal parameters selectively based on the respective first received signal strength training data; one or more further received signal parameters selectively based on the respective second received signal strength training data; one or more further received signal parameters based on the combination of the respective first and second received signal strength training data.

61. A machine learning model according to any one of examples 57 to 60 wherein the one or more further received signal parameters comprise one or more comparative received signal parameters, each of the one or more comparative received signal parameters being based on a respective comparison of (e.g. corresponding features of) the respective first and second received signal strength training data.

62. A machine learning model according to any one of examples 57 to 61 wherein the one or more training data sets comprises at least first and second training data sets, the first training data set being based on received signal strength training data associated with (e.g. captured in respective tag volumes of) a first pair of tag volumes and the second training data set being based on received signal strength training data associated with (e.g. captured in respective tag volumes of) a second pair of tag volumes different from first pair of tag volumes.

63. One or more non-transitory computer readable media having a trained machine learning model according to any one of examples 56 to 62 stored therein.

64. One or more non-transitory computer readable media having a trained machine learning model for determining a location of an RFID tag stored therein, the machine learning model being configured to:
receive input data based on point of peak data indicative of a location with respect to first and second tag volumes of peak received signal strength from the tag and value(s) of one or more further received signal parameters (such as any one or more of the received signal parameters discussed herein), the said point of peak data and value(s) of the one or more further received signal parameters being based on first and second received signal strength data, the first received signal strength data being associated with a first tag volume and relating to signals received from the tag at a first plurality of locations relative to the tag and the second received signal strength data being associated with a second tag volume and relating to signals received from the tag at a second plurality of locations relative to the tag;
determine based on the input data which of the first and second tag volumes the tag is more likely to be located in; and
output an indication of which of the first and second tag volumes the tag is more likely to be located in based on the said determination.

65. The one or more non-transitory computer readable media of example 64 wherein the trained machine learning model is configured to determine based on the input data which of the first and second tag volumes the tag is more likely to be located in by determining a classification of the input data.

66. A (e.g. computer-implemented) method of determining a location of an RFID tag, the method comprising:
obtaining input data based on point of peak data indicative of a location with respect to first and second tag volumes of peak received signal strength from the tag and value(s) of one or more further received signal parameters (such as any one or more of the received signal parameters discussed herein), the said point of peak data and values of said parameter(s) being based on first and second received signal strength data, the first received signal strength data being associated with a first tag volume and relating to signals received from the tag at a first plurality of locations relative to the tag and the second received signal strength data being associated with a second tag volume and relating to signals received from the tag at a second plurality of locations relative to the tag;
determining based on the input data which of the first and second tag volumes the tag is more likely to be located in; and
outputting an indication of which of the first and second tag volumes the tag is more likely to be located in based on the said determination.

67. The method of example 66 wherein the point of peak data is indicative that the location of peak received signal strength from the tag is associated with a first one of the first and second tag volumes, wherein determining based on the input data which of the first and second tag volumes the tag is more likely to be located in comprises determining that the RFID tag is located in a different one of the first and second tag volumes from the said first one depending on the determined values of the further received signal parameters.

68. A computer program product comprising instructions which, when the program is executed by a computer, cause the computer to carry out the method of any one of examples 1 to 55 or the method of example 66 or example 67.

69. One or more non-transitory computer readable media storing machine-readable instructions which, when executed (e.g. by one or more processors), cause one or more processors to perform the method of any one of examples 1 to 55 or the method of example 66 or example 67.

70. Apparatus comprising means to perform the method according to any one of examples 1 to 55 or the method of example 66 or example 67.

71. Data processing apparatus comprising one or more processors, the data processing apparatus being configured to perform the method of any one of examples 1 to 55 or the method of example 66 or example 67.

Throughout the description and claims of this specification, the words “comprise” and “contain” and variations of them mean “including but not limited to”, and they are not intended to (and do not) exclude other components, integers or operations. Throughout the description and claims of this specification, the singular encompasses the plural unless the context demands otherwise. In particular, where the indefinite article is used, the specification is to be understood as contemplating plurality as well as singularity, unless the context demands otherwise. All of the features disclosed in this specification (including any accompanying claims, abstract and drawings), and/or all of the elements of any method or process so disclosed, may be combined in any combination, except combinations where at least some of such features and/or operations are mutually exclusive. Implementations are not restricted to the details of any foregoing examples.

1. A method of determining a location of an RFID tag, the method comprising:
obtaining first received signal strength data associated with a first tag volume and relating to signals received from the tag at a first plurality of locations relative to the tag, and second received signal strength data associated with a second tag volume different from the first tag volume and relating to signals received from the tag at a second plurality of locations relative to the tag;
determining, depending on the first and second received signal strength data, point of peak data indicative of a location with respect to the first and second tag volumes of peak received signal strength from the tag;
determining value(s) of one or more further received signal parameters depending on the first and second received signal strength data; and
determining which of the first and second tag volumes the RFID tag is more likely to be located in depending on the point of peak data and on the determined values of the one or more further received signal parameters.

2. The method of claim 1 wherein the one or more further received signal parameters comprise a plurality of received signal parameters, the said plurality of received signal parameters relating to a plurality of different features of the first received signal strength data and a corresponding plurality of features of the second received signal strength data.

3. The method of claim 1 wherein the one or more further received signal parameters comprise any two or more of: one or more further received signal parameters selectively based on the first received signal strength data; one or more further received signal parameters selectively based on the second received signal strength data; and one or more further received signal parameters based on the combination of the first and second received signal strength data.

4. The method of claim 1 wherein the one or more further received signal parameters comprise one or more comparative received signal parameters, each of the one or more comparative received signal parameters being based on a respective comparison of the first and second received signal strength data.

5. The method of claim 1 wherein the one or more further received signal parameters comprise one or more read count parameters relating to a number of reads of the tag.

6. The method of claim 1 wherein the one or more further received signal parameters comprise one or more read count parameters relating to a number of reads of the tag per unit time.

7. The method of claim 1 wherein the one or more further received signal parameters comprise one or more average received signal strength parameters relating to an average received signal strength of signals received from the tag.

8. The method of claim 1 wherein the one or more further received signal parameters comprise one or more parameters relating to a variation of received signal strengths of signals received from the tag.

9. The method of claim 1 wherein the one or more further received signal parameters comprise one or more signal strength parameters relating to a peak signal strength received from the tag.

10. The method of claim 1 wherein the one or more further received signal parameters comprise one or more parameters relating to a time or location at which a peak received signal strength was received from the tag.

11. The method of claim 1 wherein the first and second received signal strength data is based on time stamped received signal strength data relating to signals received from the tag at the said first and second pluralities of locations relative to the tag, and wherein the point of peak data comprises data relating to a time at which a signal having the peak received signal strength of the first and second received signal strength data was received.

12. The method of claim 1 wherein determining which of the first and second tag volumes the RFID tag is more likely to be located in comprises causing a comparison of input data to predetermined reference data, the input data being based on the point of peak data and the determined value(s) of the one or more further received signal parameters.

13. The method of claim 1 wherein determining which of the first and second tag volumes the RFID tag is more likely to be located in comprises:
causing input data to be input to a trained machine learning model, the input data being based on the point of peak data and the determined value(s) of the one or more further received signal parameters; and
obtaining from the trained machine learning model an indication of which of the first and second tag volumes the RFID tag is more likely to be located in.

14. The method of claim 13 further comprising obtaining from the trained machine learning model a probability that the RFID tag is located in the said tag volume of the first and second tag volumes.

15. The method of claim 13 wherein the machine learning model is trained based on training data at least some of which is associated with tag volumes different from the first and second tag volumes.

16. The method of claim 13 wherein the machine learning model is trained based on one or more training data sets, each of the one or more training data sets being based on a known one of first and second training tag volumes in which an RFID tag is located, point of peak data indicative of a location with respect to the first and second training tag volumes of peak received signal strength from the RFID tag and training value(s) of the one or more further received signal parameters.

17. A computer-implemented method of training a machine learning model for determining a location of an RFID tag, the method comprising:
obtaining first received signal strength data associated with a first tag volume and relating to signals received from one or more RFID tags at a first plurality of locations relative to the tag(s), and second received signal strength data associated with a second tag volume different from the first tag volume and relating to signals received from one or more RFID tags at a second plurality of locations relative to the tag(s);
generating a training data set by, for each of the one or more RFID tags, determining, depending on the first and second received signal strength data, point of peak data indicative of a location with respect to the first and second tag volumes of peak received signal strength from the tag, determining value(s) of one or more further received signal parameters depending on the first and second received signal strength data, and identifying a respective known one of the first and second tag volumes in which the respective RFID tag is located; and
training the machine learning model based on the training data set.

18. The computer-implemented method of claim 17 wherein training the machine learning model comprises, for each of the one or more RFID tags:
inputting to the machine learning model input data based on value(s) of the one or more further received signal parameters and the point of peak data;
determining based on the input data and the machine learning model which of the first and second tag volumes is more likely to contain the RFID tag and outputting an indication thereof;
comparing the said indication output by the machine learning model to the known one of the first and second tag volumes in which the tag is located; and
refining the machine learning model depending on the comparison between the said indication output by the machine learning model and the known one of the first and second tag volumes in which the tag is located.

19. The computer-implemented method of claim 17 wherein generating the training data set comprises any two or more of: determining one or more further received signal parameters selectively based on the first received signal strength data; determining one or more further received signal parameters selectively based on the second received signal strength data; and determining one or more further received signal parameters based on the combination of the first and second received signal strength data.

20. The computer-implemented method of claim 17 wherein the one or more further received signal parameters comprise one or more comparative received signal parameters, each of the one or more comparative received signal parameters being based on a respective comparison of the first and second received signal strength data.

21. The computer-implemented method of claim 17 further comprising:
obtaining third received signal strength data associated with a third tag volume and relating to signals received from one or more RFID tags at a third plurality of locations relative to the tag(s), and fourth received signal strength data associated with a fourth tag volume different from the third tag volume and relating to signals received from one or more RFID tags at a fourth plurality of locations relative to the tag(s);
generating a further training data set by, for each of the one or more RFID tags, determining, depending on the third and fourth received signal strength data, point of peak data indicative of a location with respect to the third and fourth tag volumes of peak received signal strength from the tag, determining value(s) of one or more further received signal parameters depending on the third and fourth received signal strength data, and identifying a respective known one of the third and fourth tag volumes in which the respective RFID tag is located; and
training the machine learning model based on the further training data set.

22. A computer-implemented method of generating a training data set for training a machine learning model for determining a location of an RFID tag, the method comprising:
obtaining first received signal strength data associated with a first tag volume and relating to signals received from one or more RFID tags at a first plurality of locations relative to the tag(s), and second received signal strength data associated with a second tag volume different from the first tag volume and relating to signals received from one or more RFID tags at a second plurality of locations relative to the tag(s); and
generating a training data set by, for each of the one or more RFID tags, determining, depending on the first and second received signal strength data, point of peak data indicative of a location with respect to the first and second tag volumes of peak received signal strength from the tag, determining value(s) of one or more further received signal parameters depending on the first and second received signal strength data, and identifying a respective known one of the first and second tag volumes in which the respective RFID tag is located.

23. A computer-implemented method according to claim 17 wherein the one or more further received signal parameters comprise a plurality of received signal parameters, the said plurality of received signal parameters relating to a plurality of different features of the first received signal strength data and a corresponding plurality of features of the second received signal strength data.

24. A method of determining a location of an RFID tag, the method comprising:
obtaining input data based on point of peak data indicative of a location with respect to first and second tag volumes of peak received signal strength from the tag and value(s) of one or more further received signal parameters, the said point of peak data and values of said parameter(s) being based on first and second received signal strength data, the first received signal strength data being associated with a first tag volume and relating to signals received from the tag at a first plurality of locations relative to the tag and the second received signal strength data being associated with a second tag volume and relating to signals received from the tag at a second plurality of locations relative to the tag;
determining based on the input data which of the first and second tag volumes the tag is more likely to be located in; and
outputting an indication of which of the first and second tag volumes the tag is more likely to be located in based on the said determination.

25. One or more non-transitory computer readable media having a trained machine learning model for determining a location of an RFID tag stored therein, the machine learning model being configured to:
receive input data based on point of peak data indicative of a location with respect to first and second tag volumes of peak received signal strength from the tag and value(s) of one or more further received signal parameters, the said point of peak data and values of said parameter(s) being based on first and second received signal strength data, the first received signal strength data being associated with a first tag volume and relating to signals received from the tag at a first plurality of locations relative to the tag and the second received signal strength data being associated with a second tag volume and relating to signals received from the tag at a second plurality of locations relative to the tag;
determine based on the input data which of the first and second tag volumes the tag is more likely to be located in; and
output an indication of which of the first and second tag volumes the tag is more likely to be located in based on the said determination.

26. A machine learning model trained by the computer-implemented method of claim 17.

27. A non-transitory computer readable medium storing machine readable instructions which, when executed, cause the one or more processors to perform the method of claim 1.

28. A data processing apparatus comprising one or more processors, the data processing apparatus being configured to perform the method of claim 1.
